(19) United States
(12) Patent Application Publication
(10) Pub. No.: US 2026/0370718 A1
(43) Pub. Date: Nov. 19, 2026

(54) METHODS, ARCHITECTURES, APPARATUSES AND SYSTEMS DIRECTED TO CROSS-USER AR PROCESSING AND RESOURCE SHARING FOR ENABLING DYNAMIC AND CUSTOMIZED AR EXPERIENCE

(71) Applicant: InterDigital Patent Holdings, Inc., Wilmington, DE (US)

(72) Inventors: Xu LI, Plainsboro, NJ (US); Chonggang WANG, Princeton, NJ (US); Robert GAZDA, Spring City, PA (US)

(21) Appl. No.: 19/154,241

(22) PCT Filed: Feb. 8, 2024
(86) PCT No.: PCT/US2024/014989

§ 371 Date: Aug. 6, 2025

Related U.S. Application Data
(60) Provisional application No. 63/444,782, filed on Feb. 10, 2023.

(51) Int. Cl. H04L 67/131; H04W 4/02; H04W 76/14

(52) U.S. Cl. CPC H04L 67/131; H04W 4/027; H04W 76/14

(57) ABSTRACT

Procedures, methods, architectures, apparatuses, systems, devices, and computer program products directed to cross-user augmented reality (AR) processing and resource sharing for enabling dynamic and customized AR experience are described. A first wireless transmit/receive unit (WTRU) may be configured to send, to a network element, an AR resource request indicating (1) a requested type of AR resources and (2) localization information associated with the first WTRU. The first WTRU may be further configured to receive, from the network element, an AR resource response comprising first information for communicating with a second WTRU capable of providing AR resources based on the requested type of AR resources and the localization information. The first WTRU may be further configured to send to the second WTRU, an AR resource sharing request indicating at least one of the

### CROSS-REFERENCE TO RELATED APPLICATIONS

This application claims the benefit of U.S. Patent Application No. 63/444,782 filed Feb. 10, 2023, which is incorporated herein by reference in its entirety.

### TECHNICAL FIELD

The present disclosure is generally directed to the fields of communications, software and encoding, including, for example, methods, architectures, apparatuses, systems directed to cross-user augmented reality (AR) processing and resource sharing for enabling dynamic and customized AR experience.

### BACKGROUND

Augmented reality (AR) may be seen as integrating the virtual world with the physical world by applying (e.g., overlaying) virtual information (e.g., assets, scenes) to the physical world. In AR applications, the real world and virtual objects may coexist in the same viewport of a user, thereby augmenting the user's real sensory experience. Embodiments described herein have been designed with the foregoing in mind.

### BRIEF SUMMARY

Briefly stated, according to one embodiment, a first wireless transmit/receive unit (WTRU) comprising a processor and a transceiver operatively coupled to the processor is described herein. In an example, the processor and the transceiver may be configured to send, to a network element, an AR resource request indicating (1) a requested type of AR resources and (2) localization information associated with the first WTRU (e.g., and a physical environment). In an example, the processor and the transceiver may be further configured to receive, from the network element, an AR resource response comprising first information for communicating with a second WTRU capable of providing one or more AR resources of (e.g., based on) the requested type (e.g., and the localization information). In an example, the processor and the transceiver may be further configured to send to the second WTRU an AR resource sharing request indicating at least one of the requested type of AR resources and the localization information. In an example, the processor and the transceiver may be further configured to receive, from the second WTRU, an AR resource sharing response indicating an agreement to provide the requested type of AR resources.

According to one embodiment, a second WTRU comprising a processor and a transceiver operatively coupled to the processor is described herein. In an example, the processor and the transceiver may be configured to send, to a network element, AR capability information indicating (1) at least one type of AR resources that the second WTRU may be capable of providing and (2) localization information associated with the second WTRU (e.g., in a physical environment). In an example, the processor and the transceiver may be configured to receive from a first WTRU an AR resource sharing request indicating the at least one type of AR resources that the second WTRU may be capable of providing. In an example, the processor and the transceiver may be configured to determine to provide one or more AR resources of the at least one type of AR resources (e.g., associated with the physical environment) based on an availability of processing resources in the second WTRU. In an example, the processor and the transceiver may be configured to send to the first WTRU an AR resource sharing response indicating an agreement to provide the at least one type of AR resources. According to one embodiment a first and a second methods are disclosed herein, where the first method and the second method may comprise the steps performed respectively by the first WTRU and the second WTRU described herein.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example of a dynamic and customized AR experience for exploring a new city street;

FIG. 3 is a diagram illustrating an example of cross-user collaborative AR resource sharing;

FIG. 4 is a diagram illustrating an example of AR device architecture for realizing the cross-user collaborative AR processing and resource sharing;

FIG. 5 is a diagram illustrating four examples of AR device functional architectures of an AR resource consumer (ARRC);

FIG. 6 is a diagram illustrating three examples of AR device functional architectures of an AR resource provider (ARRP);

FIG. 7A is a diagram illustrating an example procedure for enabling cross-user collaboration relationship establishment;

FIG. 7B is a diagram illustrating another example procedure for enabling cross-user collaboration relationship establishment;

FIG. 8 is a diagram illustrating an example procedure for enabling original video frame sharing;

FIG. 9 is a diagram illustrating an example procedure for enabling physical world knowledge sharing for physical objection detection and recognition;

FIG. 10 is a diagram illustrating an example procedure for enabling physical world knowledge accuracy and freshness validation;

FIG. 11 is a diagram illustrating an example procedure for enabling pre-notification associated with moving PO appearance;

FIG. 12 is a diagram illustrating an example 3 GPP SA4 implementation of the ARD architecture for supporting cross-user AR processing and resource sharing;

FIG. 13 is a diagram illustrating an example 3 GPP SA2 implementation for the cross-user collaboration relationship establishment;

FIG. 14 is a diagram illustrating an example 3 GPP SA6 implementation;

FIG. 15 is a diagram illustrating an example ETSI augmented reality framework (ARF) implementation;

FIG. 16 is a diagram illustrating an example method for enabling cross-user collaboration relationship establishment; and

FIG. 17 is a diagram illustrating another example method for enabling cross-user collaboration relationship establishment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

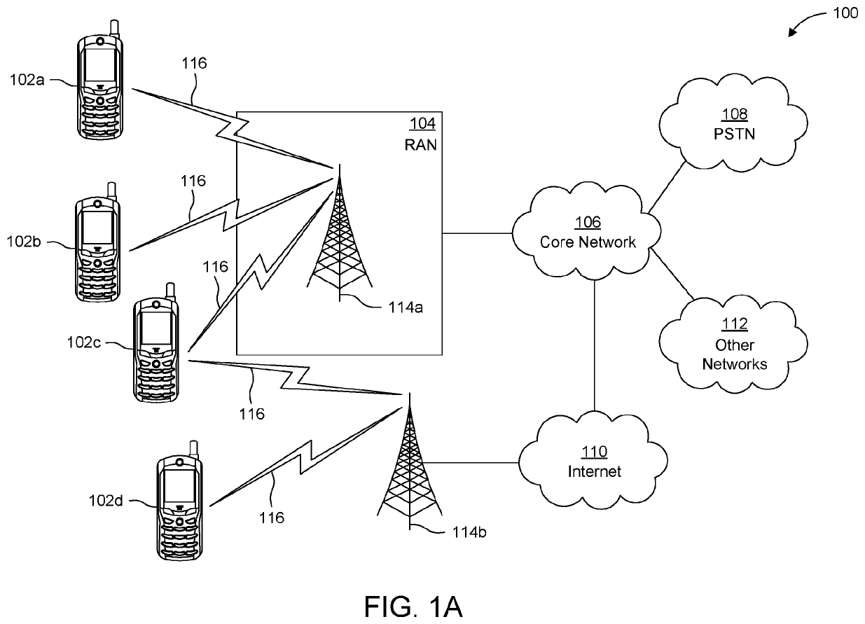

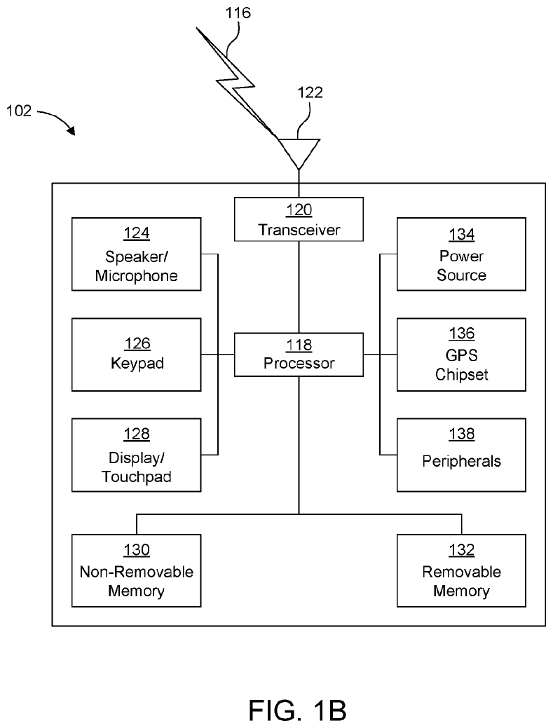

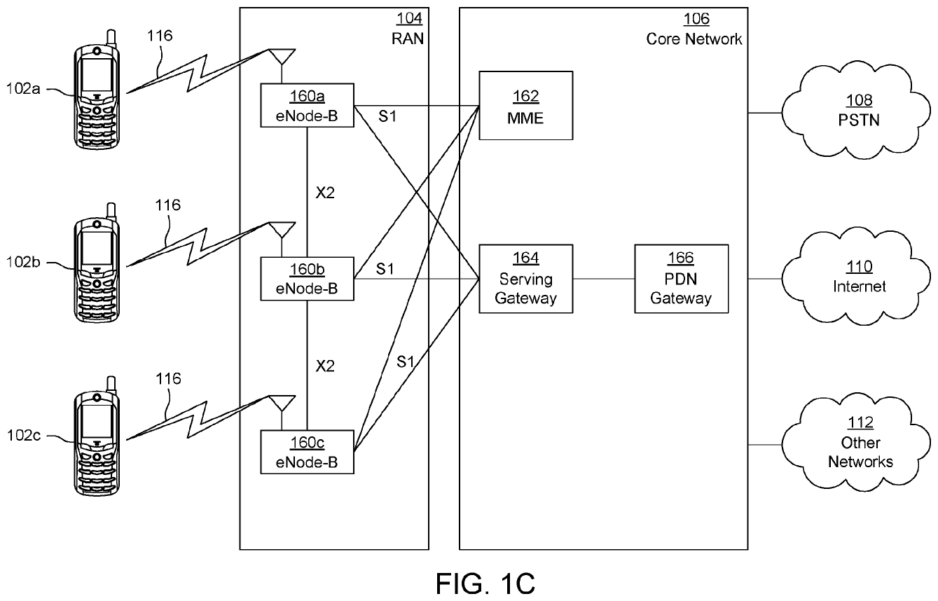

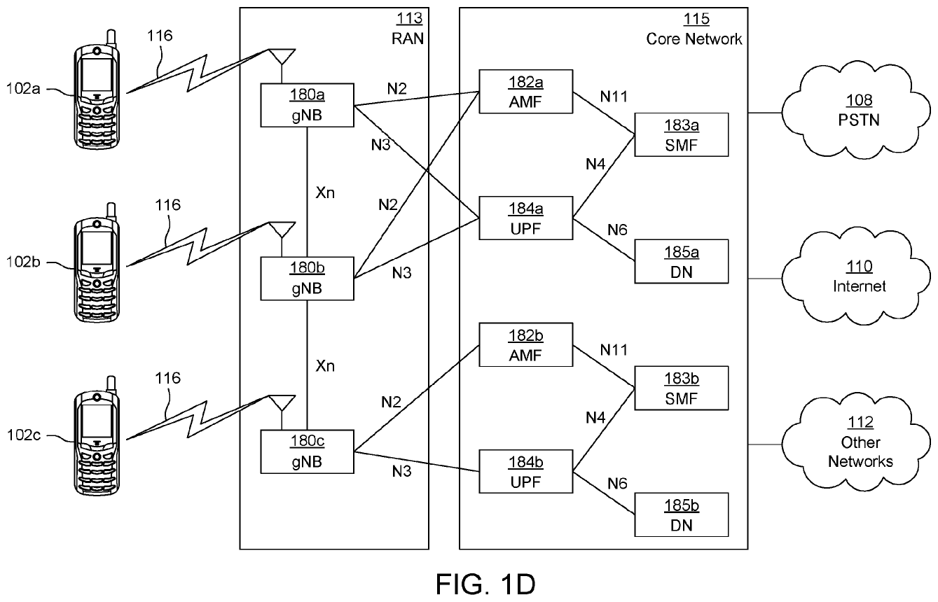

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized by WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Throughout embodiments described herein the terms “serving base station”, “base station”, “gNB”, “network” collectively “gNB” may be used interchangeably to designate any network element such as e.g., a network element acting as a serving base station. Embodiments described herein are not limited to gNBs and are applicable to any other type of serving base stations.

For the sake of clarity, satisfying, failing to satisfy a condition and “configuring condition parameter(s) are described throughout embodiments described herein as relative to a threshold (e.g., greater, or lower than) a (e.g., threshold) value, configuring the (e.g., threshold) value, etc.). For example, satisfying a condition may be described as being above a (e.g., threshold) value, and failing to satisfy a condition (e.g., performance criteria) may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein the terms “send a request (or response)” may be used interchangeably with “send information indicating a request (or response)”.

Throughout embodiments described herein the terms “augmented reality device (ARD)” and “WTRU” may be used interchangeably to designate any wireless device comprising AR capability. Throughout embodiments described herein the terms “first ARD”, “ARD-1”, “first WTRU” and “AR resource consumer (ARRC”) may be used interchangeably to designate any AR capable WTRU operating as an AR resource consumer. Throughout embodiments described herein the terms “second ARD”, “ARD-2”, “second WTRU” and “AR resource provider (ARRP”) may be used interchangeably to designate any AR capable WTRU operating as an AR resource provider e.g., for an ARRC.

Throughout embodiments described herein the term “location A” may be used interchangeably with “first location”, the term “location B” may be used interchangeably with “second location” and the term “location C” may be used interchangeably with “third location”.

Throughout embodiments described herein the terms “physical world knowledge” and “physical world knowledge information” may be used interchangeably to designate any piece of information including any kind of knowledge about a physical (e.g., real) environment.

Throughout embodiments described herein the terms “type of requested AR resource” and “requested type of AR resources” may be used interchangeably.

### Overview

Existing AR applications are rudimentary (e.g., providing basic AR effects, pre-designed AR design, pre-selected (e.g., pre-configured) virtual objects, etc.). Future AR applications may be more advanced, more dynamic, and more customized. In an example, an AR Device (ARD) may dynamically complete an AR scene designed locally onsite (e.g., in a case where the ARD enters an unknown or new physical environment). Compared to existing centralized or predesigned-based AR scene design, embodiments described herein may enable individualized (e.g., customized) AR experiences. For example, advanced AR processing may include two stages (e.g., steps). Advanced AR processing may include a first stage of dynamic (e.g., and customized) AR scene design for a new environment, which may further involve a first task of physical target object (PTO) determination for the physical environment, and a second task of virtual object (VO) selection (e.g., and preparation).

A PTO may be a physical object (PO) in the physical environment that may be augmented with an AR effect. An AR effect may be seen as a perceived AR experience of a user. Augmenting a PO with an AR effect may be realized, for example, by superimposing one or more virtual asset(s) (e.g., object(s)) onto rendered physical object of the real-world.

For a PTO, it may be determined what kind of VO may be superimposed to the PTO and a VO may be prepared (e.g., a VO, which may be of large size may be downloaded if not locally stored and VO's behavior (and/or appearance) may be configured in a customized way, based on, for example, user preferences).

Advanced AR processing may include a second stage of AR scene deployment for execution and rendering, which may include any of deploying a designed AR scene to an AR processor (ARP) for execution, conducting VO registration (e.g., superimposing VOs to the PTOs) and AR rendering (the rendered content sent to display for presenting to the user when visiting the physical environment).

Existing AR solutions are not able to provide dynamic and customized AR experience as described herein. In an example, existing solutions may focus on how an AR device may leverage computing resources of the edge infrastructure e.g., for boosting the processing speed of AR scene execution and rendering, but they do not allow to provide dynamic and customized AR scene design as described herein. Furthermore, existing solutions do not allow “cross-user collaborative AR processing” (e.g., device-to-device collaboration). For example, after device-to-device collaboration may be enabled, other potential types of resource sharing (besides computing resources) for supporting advanced AR processing may be realized.

Embodiments described herein may allow to enable cross-user AR processing and resource sharing for supporting dynamic and customized AR experiences. Embodiments described herein may allow an ARD to obtain relevant (e.g., useful) AR-related resources (shared by other ARDs), such as e.g., any of video frames and the physical world knowledge (e.g., extracted from the video frames) about a physical environment, earlier than what may be provided by existing non-device collaborative solutions. Embodiments described herein may allow the ARD to get familiar (e.g., receive information associated) with the physical environment e.g., before visiting (e.g., arriving entering) in that physical environment. The ARD may have more time to perform dynamic AR design and processing for AR scene deployment and rendering, creating richer AR experiences.

A functional architecture for an ARD, which may be acting in the logical role of an AR resource provider (ARRP) is described herein.

A functional architecture for an ARD, which may be acting in the logical role of an AR resource consumer (ARRC) is described herein.

In a case where an ARRC expects to obtain AR resources (e.g., any of the original video frames and the physical world knowledge extracted from video frames) from an ARRP, a collaboration (e.g., resource-sharing) relationship may be established. A procedure for enabling cross-user collaboration relationship establishment is described herein.

Two types of AR resource-sharing between an ARRP and an ARRC, which may be referred to herein as Type-1 and Type-2 are described herein.

In the first type (e.g., Type-1) of AR resource sharing, which may be referred to herein as original video frame sharing, the ARRC may send a request to ARRP to share its original video frames and the ARRC may perform further AR processing to extract physical world knowledge. A procedure to enable original video frame sharing between an ARRP and an ARRC is described herein.

In the second type (e.g., Type-2) of AR resource sharing, which may be referred to herein as physical world knowledge sharing, a part of the AR processing may be directly performed by an ARRP on behalf of an ARRC. For example, the ARRC may send an AR resource-sharing request to ARRP, indicating a request to share physical world knowledge. For example, (e.g., only) physical world knowledge information may be returned (e.g., transmitted) to the ARRC. Different procedures are described herein, depending on how the physical world knowledge may be leveraged by the ARRC.

The first type and the second type of AR resource sharing may be used in combination, such that original video frames and physical world knowledge may be shared (e.g., at the same time) between an ARRC and an ARRP.

A first procedure for enabling physical object detection and recognition is described herein. In this procedure, the ARRC may request the ARRP to obtain useful (e.g., relevant) physical world knowledge information (e.g., indicating the PTOs) about an (e.g., unknown) physical environment X.

A second procedure for enabling knowledge accuracy and freshness validation is described herein. In this procedure, the ARRC may hold (e.g., have, include) some physical world knowledge about a physical environment X (which the ARRC may/might not have arrived, entered yet). For example, the knowledge may be out of date. The ARRC may ask (e.g., request) the ARRP to validate the accuracy and freshness of the knowledge held by the ARRC.

A third procedure for enabling pre-notification about moving PO appearance is described herein. In this procedure, the ARRP may detect moving POs, which may/might not yet be into the viewport of the ARRC. The ARRP may send information indicating a pre-notification to an ARRC such that the ARRC may know (e.g., be informed of) the upcoming appearances of the POs in advance so that the ARRC may have more time to prepare the AR effect to be used on such moving POs (e.g., before it appears in the ARRC's viewport).

### Augmented Reality (AR) Overview

Augmented Reality (AR) may be seen as integrating the virtual world with the physical world by applying (e.g., overlaying) virtual information (e.g., assets, scenes) to the physical world. In AR applications, the real world and virtual objects may coexist in the same viewport of a user, thereby augmenting the user's real sensory experience. AR applications may have three (e.g., major) features (e.g., characteristics). A first feature may be the combination of the virtual world and the real world. A second feature may be real-time interaction. AR users may interact with the AR system in real-time using any of their gestures, voice, touch, etc. A third feature may be virtual object registration, which may refer to the tracking and positioning of virtual assets (e.g., objects) in the real world such that the virtual information (e.g., assets) may be superimposed onto the real world. The main enabling technologies for AR may involve any of multimedia, 3D modeling, sensors, computer vision (such as e.g., any of object recognition and detection, real-time object tracking and virtual assets registration), and video rendering.

An example of AR processing pipeline may be as follows. First, a camera of an AR device may capture video frames from the real world. Then, the AR device may conduct (e.g., perform) the feature extraction operation from the video frames. Based on the extracted feature information, the AR device may conduct (e.g., perform) object recognition to recognize one or more physical objects (POs). For example, based on business logic, the AR device may determine whether some of the POs may be the physical target objects (PTOs), which may be POs to be annotated (e.g., augmented) with AR effect. For example, any of marker-based and marker less-based techniques may be used for determining where to place the VO in the physical environment. An AR effect may be a perceived AR experience of a user. Augmenting a PO with an AR effect may be realized by superimposing one or more virtual asset(s)/object(s) onto the physical object of the real-world. Virtual asset and virtual object (VO) may be used interchangeably throughout embodiments described herein.

Simultaneous localization and mapping (SLAM) technology may also be conducted (e.g., used, performed), to establish a world map and to locate the AR device in the map. These operations may enable the AR device to extract relevant (e.g., useful) knowledge about the real (e.g., physical) world. Depending on e.g., business logic, the AR device may select an appropriate VO to be superimposed onto a PTO. For example, a VO may be any of a static sign, a dynamic (e.g., moving) cartoon character, a decoration, etc. During this process, the VO may maintain a precise alignment with the PTO to be annotated in the physical environment. This can be achieved through 3D tracking and registration technology. The positioning process of overlaying the VO in an exact (e.g., perfect) position in the real world is referred to herein as VO registration. The performance of VO registration may depend on the accuracy of the physical world knowledge held by the AR device. For example, the generated 3D map or model about the physical world via SLAM may be used to accurately estimate the pose (position+orientation) of the camera of the AR device. The AR device may track (and react) to various real-time changes (such as e.g., any of the user's current position, head angle, motion, etc.) in order to re-establish the coordinate system alignment according to the user's current viewport and may keep the VO in the appropriate position. For example, e.g., to avoid repetitive PTO detection in (e.g., every) video frame, the AR device may take the initial video frame as input and may conduct object tracking between multiple frames. For example, rendering may be performed to create the final AR effect, which may be delivered and shown on the display for presenting to users.

In an example, for a physical environment X, an example of AR scene design, to be applied for creating and delivering an AR experience to the user in the physical environment X may involve two major tasks:

The first task of an AR scene design may comprise PTO determination for a physical environment. A PTO may be seen as a PO in the real world to be augmented with an AR effect. For example, an AR device may superimpose virtual information (e.g., a VO) onto a PTO such that from a user's viewport, the physical world may be integrated or enhanced with the virtual asset (e.g., information, content). Determining which POs may be PTOs may depend on the application business logic. Detecting and recognizing PTOs may involve AR processing technology such as e.g., object detection and recognition technology in the computer vision domain. In existing AR applications, PTOs may be detected based on e.g., the marker-based VO registration approach. The AR device may capture, recognize, and locate a visual marker (e.g., a fiducial marker) in the video frames of the camera. The VO may be annotated onto that marker. Another example may be the marker less-based VO registration approach. A TikTok app may leverage natural features to detect human faces such that different face effects may be added in real-time (such as adding a hat, beards, and other virtual objects). Detecting (e.g., locating) a human face in a camera view may be performed in real-time.

The second task of an AR scene design may comprise VO selection and preparation. For example, for a PTO, it may be determined what kind of VO may be superimposed to the PTO. For example, a VO may be a 3D virtual asset, which may be represented as a file, including the data structure (e.g., information) about the VO, such as e.g., any of its shape, geometry, color and texture (determining VO's appearance). For example, the VO's behavior may (e.g., also) be configured. A VO's appearance may refer to what the VO may look like (e.g., a Hello Kitty cat, a 3D hat, a cartoon superman character, etc.) including any of its shape, color, texture, etc. For example, a VO designer may use an AR authoring tool to design a 3D virtual asset (e.g., VO), which may be published in a 3D asset store for usage by one or more AR applications. The VO may be associated with, for example, a (e.g., planned) behavior. The VO may provide configuration APIs such that the VO's behavior may be configured in a case where it is used in an AR scene. In existing (e.g., basic) AR applications, preparing VO may be basic. For example, when TikTok users may add face effects, the VOs (such as a hat, and beards) may be stored locally and in a reduced size (as small props).

In an example, in an AR scene design, VO selection and preparation may be conducted first, and PTO may be determined after having conducted the VO selection and preparation. For example, an AR design may first decide what VO may be used, then depending on VO's behavior, PTOs will be selected.

### Overview of 3GPP Activities on AR

3GPP SA4 has a series of works focusing on AR, Virtual Reality (VR)/Extended Reality (XR). For example, 3GPP TR 26.918 “Virtual Reality (VR) media services over 3GPP”, v.17.0.0, 2022-04-07 includes VR audio and video content production process, VR business use cases, VR audio and video quality assessment. 3GPP TS 26.118 “Virtual Reality (VR) profiles for streaming applications”, v.17.0.0, 2021-06-26 defines the operation points for VR streaming media services, and the VR client reference architecture for VR streaming media applications, etc. 3GPP TR 26.928 “Extended Reality (XR) in 5G”, v. 17.0.0, 2022-04-07 introduces XR-related content, including various XR use cases, XR basic technical background (XR delivery, XR rendering, XR visual formats, etc.), and how XR delivery can map to the 5G system architecture. 3GPP TR 26.998 “Support of 5G Glass-type Augmented Reality/Mixed Reality (AR/MR) devices”, v.17.1.0, 2022-09-23 focuses on the design of AR Glasses and defines three different AR WTRU architectures. For example. Type-1 AR devices may conduct standalone AR processing. For example, Type-2 and Type-3 AR devices may leverage computing resources on an associated WTRU or on the edge (e.g., cloud). In addition, subsequent 3GPP standardization activities are still ongoing such as 3GPP TS 26.119 “Media Capabilities for Augmented Reality”, v.0.1.0, 2022-05-02 about the media capabilities for AR and 3GPP TR 26.806 “Study on Tethering AR Glasses-Architectures, QoS and Media”, v.0.3.0, 2022-09-23 which focus on smart tethering for AR Glass.

In addition, an SA1 study item related to Metaverse (3GPP TR. 22.856. “Study on Localized Mobile Metaverse Services”, 0.2.0, 2022-09-21) focuses on a feasibility study about how to offer shared and interactive user experience of local AR contents and services, among users in proximity.

### ETSI ARF ISG Group Overview

ETSI Augmented Reality Framework Industry Specification Group (ISG ARF) aims at defining a framework for the interoperability of AR components, systems and services, as described in ETSI GS ARF 003 V1.1.1 (2020-03), “Augmented Reality Framework (ARF); AR framework architecture”. By using this framework, components from different vendors may interoperate through standard interfaces to provide an overall AR solution. For example, ETSI ARF may utilize existing 5G or 6G communication infrastructure to improve the AR design, deployment, and operation. ARF may provide support for providing portable AR components, so that AR solutions may run on different software or hardware platforms.

According to ETSI ARF an AR system may be divided into three layers, the upper layer may be the hardware layer, the middle layer may be the software layer, and the lower layer may be the data layer. The hardware layer may include any of one or more sensors, computing processing units, presentation interfaces, and user interaction interfaces. The software layer may include the vision engine (which may combine virtual content with the real world, detect (e.g., any of recognize, understand and model) the physical world) and the rendering engine (used to generate the final visualization for presentation to users). The data layer may include physical world knowledge (including any of a semantic understanding of the physical world, 3D models, and 3D maps), etc.

The functional architecture defined by ETSI ARF, may involve three functions: 1) physical world knowledge management, including any of physical world capture, physical world analysis, semantic understanding, and physical world knowledge storage; 2) AR scene management, including AR scene design (e.g., using AR authoring tools for designing AR scene) and 3D virtual asset preparation. Concerning the scene data format, a scene graph or scene description may describe a virtual asset, which may be a tree-based data structure (glTF 2.0 format may be seen as a popular scene data format as adopted by MPEG); 3) AR rendering and display. The designed scene may be rendered by the 3D rendering engine and presented to users through various display devices (such as e.g., optical see-through display, etc.).

Example of Use Case Street Walking with Dynamic and Customized AR Experience Wearable AR devices, such as AR glass, may be the next big trend in our life. Like a smartphone, an AR glass may provide similar functions as available today on a smartphone, such as e.g., making calls, accessing the Internet, etc. Compared to smartphones (which people may hold when interacting with it), wearable AR devices, such as AR glasses, may free up people's hands by supporting body gesture-based human-machine interfaces. Considering that people may wear their AR glasses all the time, those devices may capture real-time images or videos using the built-in forward High-Definition (HD) cameras without any human intervention. The captured images (e.g., videos) may include any of outdoor street views and indoor views in a case where a user is walking inside a shopping mall, an indoor exhibition event, etc. AR glasses may superimpose one or more virtual assets onto the physical world in the user's viewport for enabling a vivid AR experience.

Today's AR experiences may be basic and rudimentary and may be realized on heavy-client AR headsets (such as Microsoft HoloLens) or on lighter-weight AR glasses via computing task offloading to the Edge. For example, in existing solutions, an AR experience may be realized by a pre-designed AR scene, e.g., the PTOs to be annotated may be pre-defined, the VOs may be pre-selected or pre-configured, etc. These solutions may/might not be able to support future AR applications that may be 1) more complicated, and 2) more dynamic (e.g., online) and customized, such that the AR device may be based on a more sophisticated mechanism for AR processing. For example, the AR device may dynamically complete an AR scene design for an unknown (e.g., new) physical environment. For example, the AR device may enable a user-customized AR experience. The involved AR processing such as PTO detection and recognition (associated with physical world understanding) may involve much more AR processing power, compared to detecting a human face in a selfie camera. Similarly, for the VO selection, the VO expected by future AR applications may/might not be locally available, and some of VOs may be such huge in size that they may/might not be downloadable from a VO repository in a reasonable time. For example, today a typical 3D human character published by Unity Asset Store can be in the size of 300-500 MB. This may grow to over one GB and an AR scene may be based on many objects. For example, future VO preparation may be more computationally complex. For example, different users may expect VOs to have different customized behaviors, involving intense AR scene design processing.

Existing predefined AR scene solutions may become inefficient for more advanced AR experience and may/might not provide the dynamic and customized AR scene design expected by users.

In a first example, pre-defined AR scene design may/might not be feasible for more advanced AR experience. For example, an AR device may enter a new physical environment X for the first time and no prior knowledge may be leveraged for completing a scene design beforehand for this unknown (e.g., new) physical environment X, e.g., it may be unknown what potential PTOs may exist in the physical world, what their positions/locations/appearance, etc.

In a second example, the same pre-defined AR scene may/might not fit different AR users due to different preferences. For example, for the same VO, some users may expect this VO to be annotated on a vertical plane (such as a window or a wall of a street building), some other AR users may expect to annotate the same VO on the roof of a building. In other words, what PTO may be annotated may vary from user to user. This may add another dimension to AR scene dynamics. PTO detection and recognition may be more dynamic based on users' preferences.

In a third example, in a case where different AR users may expect to annotate the same POs, different users may like to adopt different VO(s). For example, some users may expect to use a cartoon character (e.g., Superman), other users may expect to use a different character, such as e.g., Hello Kitty.

In a fourth example, in a case where different AR users expect to annotate the same VO to the same PO, different users may want the VO appearing in their respective viewports to have different actions and behaviors.

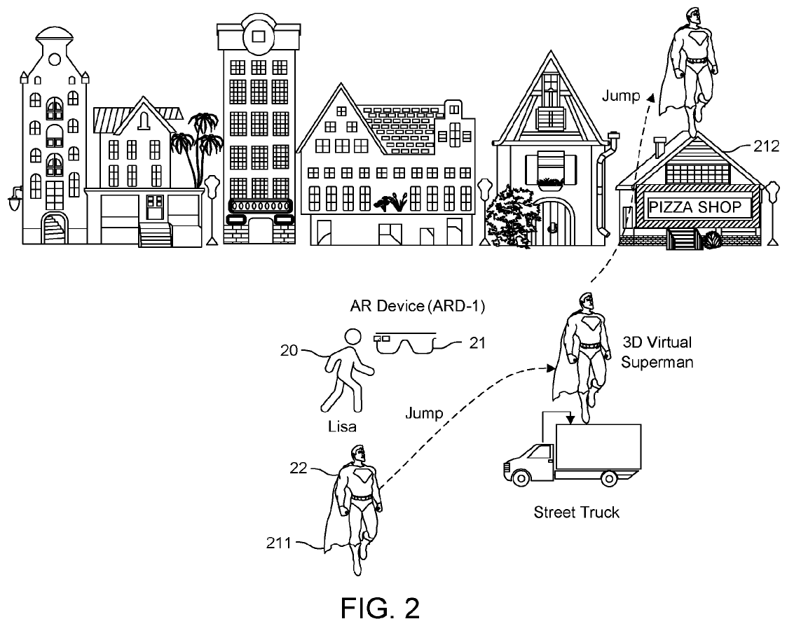

FIG. 2 is a diagram illustrating an example of a dynamic and customized AR experience for exploring a new city street. In this example, a user 20 who may be referred to herein as Lisa may be wearing AR glasses 21 (referred to herein as any of AR Device-1, ARD-1, first ARD) and may be visiting a new shopping street (e.g., which may have just been built in the downtown area of a tourism city). As Lisa 20 may be walking down the street, ARD-1 21 may capture video frames from the physical world. For example, ARD-1 21 may analyze the captured video frames in real-time via image recognition. For example, a real-time or dynamic AR scene design may be constructed (e.g., determined) with a customized approach based on e.g., Liza's preferences. For example, to design this customized AR scene, and e.g., to understand the physical world, ARD-1 21 may determine which POs may be PTOs that may be augmented with AR effects (e.g., based on Lisa's preferences). After PTOs may have been determined, ARD-1 21 may determine what kinds of VOs may be selected and what types of actions or behaviors the VO may have. Designing a dynamic and customized AR experience for Lisa 20 (walking in a new physical environment) may involve more efficient and timely AR processing than provided by existing AR solutions.

For example, VO selection and preparation may be conducted (e.g., performed) first and a 3D virtual character 22 (e.g., a virtual superman character) may be selected based on Lisa's preference. For example, 3D virtual character 22 (superman) may have customized behavior such as walking along with Lisa 20 and introducing a popular local pizza style served by a nearby pizza shop. For example, Lisa may prefer superman 22 to walk, run or jump around her to get a more vivid AR experience. For example, ARD-1 may prepare a high-fidelity VO (e.g., the 3D superman asset 22) with a detailed behavior design. For example, any of the body color, brightness, and texture of superman 22 may be configured to e.g., match the current daylight brightness of the street. The PTO determination may be conducted in an efficient way to detect and determine one or more PTOs (in this new physical environment) such as e.g., the jumping points of superman 22. For example, the behavior of superman 22 may involve identifying two PTOs 211, 212: the superman jumps from a street truck 211 (which may be referred to herein as PTO-1) to the roof of a pizza shop 212 (which may be referred to herein as PTO-2) to direct Lisa 20 to the shop, etc.

The example illustrated by FIG. 2 is an example of advanced AR experience with dynamic and customized AR scene creation in an unknown environment, that may be enabled by embodiments described herein.

To realize such advanced AR experience, the AR processing operations may be based on efficiently performing (1) a dynamic AR scene design and (2) an AR scene deployment for rendering.

Performing a dynamic AR scene design (e.g., for a new environment) may include a PTO determination for the physical environment, such as e.g., detecting and recognizing POs in a physical environment, determining which POs may be PTOs to be annotated with AR effects. Performing a dynamic AR scene design (e.g., for a new environment) may further include a VO selection and preparation, such as e.g., any of determining (e.g., selecting, downloading) the VOs, and configuring VO's customized behavior.

Performing an AR scene deployment for rendering may include any of deploying a designed AR scene to an AR processor for execution, conducting (e.g., performing) VO registration (e.g., superimposing VOs to the selected PTOs) and AR rendering (the rendered content may be sent to display for presenting to the user).

The dynamic and customized AR experience described herein may involve more implementation complexity and more efficient AR processing than available in existing AR solutions. For example, collaborative (e.g., cross-user) AR processing (e.g., and/or resource sharing) among different ARDs, which may/might not be available in existing AR solutions, may allow to improve the AR experience while mitigating the implementation complexity.

In an example, in some AR solutions, AR devices may operate independently with limited collaboration between other AR devices. For example, collaboration may be limited to VO sharing among different ARDs, where (e.g., only) VOs (e.g., visual assets) may be shared among ARDs, and the AR processing tasks of different ARDs may be conducted (e.g., performed) individually and not in a collaborative way.

To enable advanced dynamic AR experiences, e.g., in an efficient manner (any of computing load, power, timeliness, etc.), AR devices may share resources, insights, and AR assets across one or more AR processing operations. Cross-user collaborative AR processing and resource sharing are described herein, in which one or more AR processing tasks of an ARD may be helped (e.g., assisted) by one or more other ARD(s).

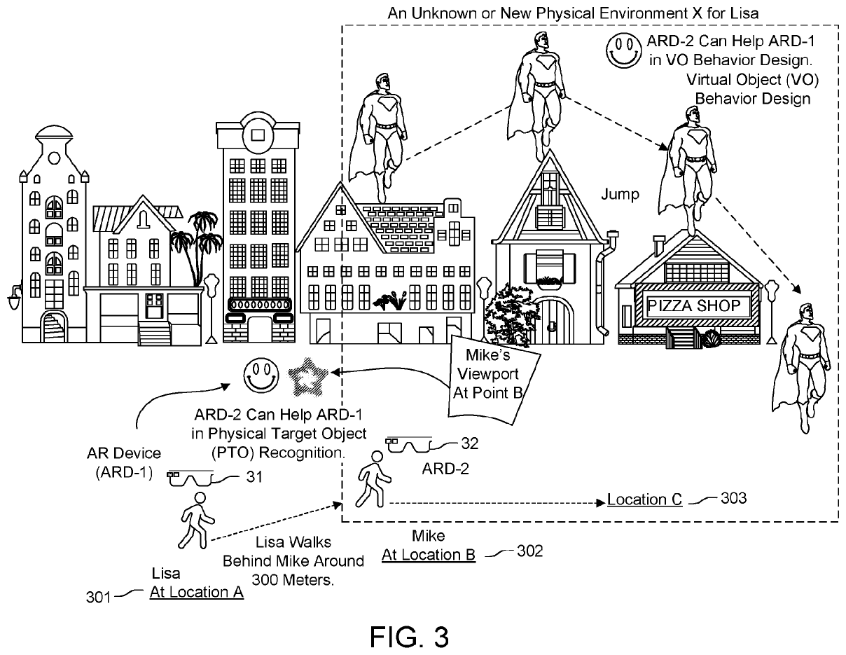

FIG. 3 is a diagram illustrating an example of cross-user collaborative AR resource sharing enabling an AR sharing experience. A second user (which may be referred to herein as Mike) may be walking from location B 302 to location C 301. A first user (which may be referred to herein as Lisa) may be three hundred meters 300 behind which may be referred to herein as location A 301. For example, Lisa may be walking towards location B 302 and towards location C 303. In this example, the video frames captured by a second ARD 32 (e.g., Mike's AR device which may be referred to herein as ARD-2) may be regarded as another type of AR resource (e.g., for sharing), which may be leveraged by a first ARD 31 (e.g., Lisa's AR device which may be referred to herein as ARD-1) for enabling (e.g., facilitating) its customized AR scene design and processing. For example, by leveraging the video frames of the second ARD 32, the first ARD 31 may be enabled to know (e.g., learn) a new (e.g., unknown) physical environment X (e.g., the street between location B 302 and location C 303) (e.g., even) in a case where the first ARD 31 is at location A 301 and has not yet arrived at location B 302. Physical world knowledge information shared by the second ARD 32 may include any of (i) the physical map of an unknown physical environment X and (ii) the semantic perception of the unknown physical environment X (such as e.g., POs detected via object recognition by the second ARD 32). Physical world knowledge information may allow the first ARD 31 to have more time to design customized AR experiences proactively and dynamically for Lisa as she may be walking between location B 302 and location C 303 at a later time. Physical world knowledge information may include (e.g., detailed) characteristics of candidate PTOs (such as e.g., any of 3D positions, shapes, orientations, colors, etc.), this may allow the first ARD 31 to accelerate (e.g., facilitate, improve) its own PTO recognition in the processing of the video frames captured from its own camera at the later time (e.g., as Lisa may be walking between location B 302 and location C 303). For example, the first ARD 31 may (e.g., quickly) validate the existence of the PTOs in its own video frames, which may be faster than starting from scratch for image recognition and may involve less computing power. For example, by knowing the PTO information shared by the second ARD 32 in advance, the first ARD 31 may (e.g., proactively) determine what VOs may be used (e.g., a superman). In a case where the VO is not locally available (e.g., and represents a large amount of data), the first ARD 31 may have sufficient time to download the superman 3D VO from a remote repository. For example, the first ARD 31 may have time to complete the customized behavior design for superman VO.

Methods, architectures, apparatuses, and systems enabling cross-user collaborative AR processing and resource sharing for enabling dynamic and customized AR experiences are described herein.

An AR device functional architecture for cross-user collaborative AR resource sharing is described herein with a first ARD acting in a first logical role of an AR resource consumer (ARRC) and a second ARD acting in a second logical role of an AR resource provider (ARRP).

A procedure for enabling cross-user collaboration relationship establishment is described herein.

Embodiments are described herein based on the following AR resource-sharing types between an ARRP and an ARRC: a first type (referred as Type-1) of AR resource sharing, where original video frames may be shared, and a second type (referred as Type-2) of AR resource sharing, where physical world knowledge may be shared. Embodiments described herein are not limited to the described original video frame sharing and physical world knowledge sharing. Embodiments described herein may be applicable to any other type of AR resource sharing between an ARRC and an ARRP.

A procedure to enable original video frame sharing between an ARRP and an ARRC is described herein.

Different procedures for sharing physical world knowledge are described herein, depending on how the physical world knowledge may be leveraged by the ARRC:

A procedure is described herein for enabling physical object detection and recognition.

A procedure is described herein for enabling knowledge accuracy and freshness validation.

A procedure is described herein for enabling pre-notification about moving PO appearance.

### Architecture for Cross-User AR Resource Sharing

A method enabling cross-user AR resource sharing for supporting dynamic and customized AR experiences is described herein. In an example, in addition to computing resources, other types of AR-related resources may be shared among different AR devices, which may include resources such as e.g., any of original video frames, physical world knowledge e.g., extracted from the original video frames (such as e.g., any of a map of an (e.g., unknown) physical environment and the semantic perception of the physical environment e.g., the detected POs in the physical environment and their characteristics), and other AR resources. For example, physical world knowledge may be shared among different ARDs based on a centralized knowledge repository. In another example, physical world knowledge may be shared in a decentralized manner, e.g., directly among multiple ARDs. Sharing physical world knowledge in a decentralized manner may provide benefits in the following examples (described using the use case of FIG. 3 as an illustration example, in which the street between location B 302 and location C 303 may be regarded as a new (e.g., unknown) physical environment for the first ARD device 31 (e.g., Lisa's AR device).

In a first example, a single world knowledge repository that may be available in the cloud and may include (e.g., all) the physical world information may represent a single-point failure and may/might not be able to provide the service.

In a second example, the street section between location B 302 and location C 303 may be a new or unpopular area, and there may be no available knowledge about this area in centralized world knowledge repository.

In a third example, the physical world knowledge about the street between location B 302 and location C 303 may be of large size. For example, Lisa's AR device 31 (e.g., ARD-1) may/might not be able to download knowledge data from the centralized repository due to any of the expensive communication cost and low-bandwidth wireless connectivity. For example, the AR applications may expect detailed images of various POs (such as a window or a sign of a pizza shop) for providing the expected characteristic information about POs, such as e.g., any of their 3D positions, orientations, colors, shapes, textures, etc.

In a fourth example, the physical world knowledge about the street between location B 302 and location C 303 may be out of date (e.g., may have been captured one or two months ago). For example, physical world knowledge may/might not be accurate and may be revalidated or calibrated. For example, changes may occur from time to time, such as e.g., movable street-parking vehicles, brightness/color of street buildings (a street may have different appearances during daytime and nighttime, for example, in a case where neon lighting or signs are used), etc.

Taking the use case described in FIG. 3 as an example, after resource sharing may have been enabled among ARDs, cross-user and collaborative AR processing may be performed, which may be reflected in the following aspects.

In a first aspect ARD-2 (Mike's ARD) may help (e.g., assist) ARD-1 (Lisa's ARD) to obtain the physical world knowledge more quickly and efficiently about an unknown (e.g., new) physical environment (e.g., street portion between locations B and C) before ARD-1 may arrive at the location. For example, the physical world knowledge may include the map or other geographical-related information. For example, ARD-2 may share the SLAM-related map information with ARD-1 to let ARD-1 know the physical world layout (e.g., road, building) or 3D model of the street between locations B and C e.g., before ARD-1 may arrive there. For example, the physical world knowledge may (e.g., also) include the semantic perception of the physical environment. For example, ARD-2 may perform computer-vision-related operations to detect and recognize one or more POs between locations B and C and may share such knowledge with ARD-1. For example, by leveraging this information, ARD-1 may know which POs may be annotated with AR effects as ARD-1 (e.g., Lisa) may be walking (e.g., moving) between locations B and C.

In a second aspect, ARD-2 may help (e.g., assist) ARD-1 with dynamic and customized AR scene design in terms of VO preparation and behavior design. Based on the physical world knowledge shared by ARD-2 about an (e.g., unknown) physical environment, ARD-1 may be aware of what kind of PTOs may exist in the (e.g., unknown) physical environment. For example, ARD-1 may (e.g., proactively) design a customized AR effect for the PTO(s) based on any of the business logic and user preferences associated with ARD-1 (e.g., Lisa). The customization may include determining what kind of VO(s) may be selected and superimposed to the PTO(s) and what behaviors the VO(s) may have. In a case where the selected VO(s) is not locally available and is of large size, ARD-1 may have time to anticipate retrieving (e.g., downloading) the selected VO(s) from a VO repository in an on-demand approach. For example, any of the AR scene design and preparation actions may be performed in advance, e.g., before Lisa may be walking between locations B and C.

In a third aspect, ARD-2 may allow ARD-1 to reduce the amount of computing resources to be used for AR processing. For example, ARD-1 may conduct (e.g., perform) customized AR scene design and preparation in advance, such that these operations may/might not be completed in the shortest time, which may further allow to reduce the usage of massive computing resources, e.g., from an edge computing host. For example, the workload (e.g., processing) for dynamic AR scene design may be amortized (e.g., spread) over a longer time. For example, sharing the physical world knowledge with ARD-2 may allow ARD-1 to avoid starting from scratch to understand the physical world as ARD-1 may be traveling between locations B and C. For example, ARD-1 may quickly re-locate or validate the existence of the PTO(s) in its own video frames based on already knowing the detailed characteristics of those PTOs, such as e.g., any of their location, shape, color, and natural features, etc. Those operations may consume fewer computing resources, which may be affordable to ARD-1 and may improve the AR processing delay.

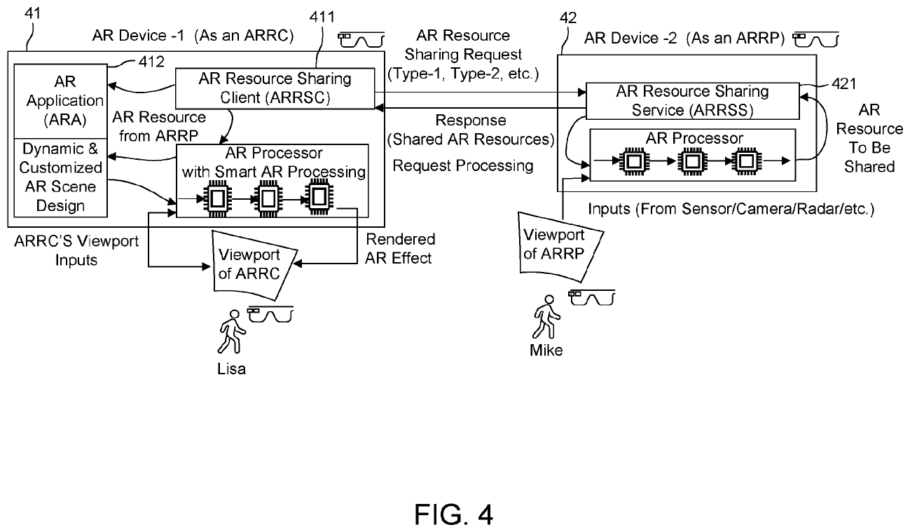

FIG. 4 is a diagram illustrating an example of AR device architecture for realizing the cross-user collaborative AR processing and resource sharing. For example, an AR device may operate in any of the two logical roles: AR resource provider (ARRP) 42 and AR resource consumer (ARRC) 41. For example, in the use case described in FIG. 3, Mike's AR device (e.g., ARD-2 ) may include an ARRP 42 and may share its video frame resource with Lisa's AR device (e.g., ARD-1 ), which may include an ARRC 41. Embodiments described herein will be described using this use case for illustration purposes. By default, throughout embodiments described herein the first ARD (e.g., Lisa's AR device, ARD-1 ) may include an ARRC 41 and the second ARD (e.g., Mike's AR device, ARD-2 ) may include an ARRP 42. For example, an AR device may include both logical roles (e.g., functions) (e.g., ARRC 41 and ARRP 42) at the same time. For example, an AR device may receive the shared AR resources sent from another AR device and may provide (e.g., share) its own resources with other AR devices. For example, an AR resource sharing coordinator (RSC) may be included in a network element to facilitate the collaboration relationship establishment between different ARDs. An RSC network element may allow to match an ARRP 42 and an ARRC 41. The RSC may be realized (e.g., included, implemented) in the RAN e.g., at a gNB, or as a network function in the CN, or as an application function (e.g., server) in an edge data network or in the cloud.

### Example of an ARD as an ARRP

An ARD including an ARRP 42 may include an AR resource sharing service (ARRSS) 421 function and an AR processor (ARP) function. The ARRSS may receive the AR resource-sharing request sent from another ARD (which may include an ARRC 41). The AR resource sharing request may include information indicating what types of AR resources the ARRC 41 may request the ARRP 42 to share.

In a first example, a first type of requested resource (e.g., Type-1) may indicate a request to share original resources such as e.g., video frames. In the first type of sharing, ARD-1 (as an ARRC) may send an AR resource request to an ARRP indicating a request to share its original (e.g., raw) video frames captured at a location of interest, which may still be unknown to the ARRC. For example, in the use case described in FIG. 3, Lisa's AR device (e.g., ARD-1 ) may send an AR resource request to Mike's AR device (ARD-2 ), indicating a request to share the video frames captured by ARD-2's built-in camera as ARD-2 may be traveling between location B and location C. In this example, the ARRP may/might not conduct (e.g., perform) AR processing on its captured video frames, which may be delivered to ARD-1 via a communication link (such as e.g., any of 3GPP device-to-device (D2D) communication, 5G-NR, CPN, local LAN). This type of AR resource sharing may be applicable, for example, in a case where the ARRP may/might not have sufficient computing resources to help the ARRC for processing video frames. Considering that the original video frames may be of high quality, this approach may incur more communication traffic than other approaches where the ARRP may perform some AR processing overhead. Type-1 sharing may/might not be limited to video frame sharing, and may be used in a broader sense for any type of AR-related original resources that may be beneficial or useful for ARRC, such as e.g., any sensor data generated by any type of sensors, radar, etc.

In a second example, a second type of requested resource (e.g., Type-2) may indicate a request to share physical world knowledge. In the second type of sharing, some of the AR processing may be performed by the ARRP on behalf of the ARRC. For example, ARD-1 (as an ARRC) may send an AR resource-sharing request to (e.g., the ARRSS hosted by) ARRP, indicating that the type of requested AR resource may be a physical world knowledge (e.g., indicating what kinds of physical world knowledge may be requested). For example, after the (e.g., ARRSS on) ARRP may have determined to serve this sharing request, the ARRSS may leverage the AR Processor of ARRP to process video frames. The output of the AR processor of ARRP may include the physical world knowledge of interest, which may be extracted from the original video frames. For example, (e.g., only) the physical world knowledge may be delivered (e.g., transmitted) to ARRC.

Embodiments described herein may be applicable to other types of AR resource sharing (e.g., other than original video frames and physical world knowledge), such as for example AR scene design solution sharing and AR group information sharing.

In an AR scene design solution sharing example, an ARD-2 (as an ARRP) may create a customized and dynamic AR scene design in a case where ARD-2 is traveling in environment X (e.g., for earning some profits). ARD-2 may share such an AR scene design with other ARDs (as ARRCs), who may/might not yet have arrived at environment X and may be there soon.

In an AR group information sharing example, for some AR applications multiple ARDs in a physical environment X may interact with each other by forming a local AR group. For example, an ARD-2 (as an ARRP) may collect the AR group information in a case where ARD-2 is traveling in the physical environment X. For example, such group information may be shared with other ARDs (as ARRCs), who may/might not yet have arrived at the physical environment X and may be there soon and may have interests to join the AR group.

An AR processor (ARP) may be seen as a module capable of performing (e.g., all the major) AR-related operations. The AR processor may collect one or more AR resources from built-in sensors and cameras. For example, the AR processor may obtain video frames from a built-in camera as input. For example, a series of AR operations may be performed by the AR processor, including extracting features from the video frames and performing PO detection and recognition. The AR processor may also realize an AR scene by performing the AR rendering operation.

### Example of an ARD as an ARRC

An ARD including an ARRC 41 may include an AR resource sharing client (ARRSC) 411 function, an AR processor (ARP) function and an AR application (ARA) 412.

In an example, the ARRSC may send an AR resource-sharing request to the (e.g., ARRSS(s) hosted by) other AR device(s) (in the role of ARRP). The AR resource sharing request may indicate what types of AR resources ARRC may request an ARRP to share. Depending on the configuration, ARRSC of the ARRC may support any of Type-1 and Type-2 of AR resource sharing between an ARRP to an ARRC:

In Type-1 (e.g., original video frame sharing), after the ARRSC of ARRC may have received the video frames from ARRP, it may forward them to the AR processor of the ARRC to perform further AR processing, such as e.g., extracting physical world knowledge.

In Type-2 (e.g., physical world knowledge sharing), some of the AR processing may be performed by ARRP on behalf of ARRC. For example, the (e.g., ARRSC of the) ARRC may send an AR resource sharing request to the (e.g., ARRSS hosted by the) ARRP, indicating a request to share physical world knowledge. For example, the ARRP may (e.g., only) return (e.g., transmit) information indicating physical world knowledge to the ARRSC.

In an example, an AR Processor included in an ARRC 41 may have the following functionalities. In the case of Type-1 sharing, the original video frames captured by an ARRP 42 may be shared with an ARRC 41. In this case, the AR Processor of the ARRC 41 may extract the physical world knowledge from the original video frames e.g., on its own. The AR Processor of an ARD-1 (as ARRC 41) may obtain, and process video frames (or AR resource inputs) captured by other ARDs (e.g., ARD-2 ) about a physical environment, which may be new (e.g., unknown) to ARD-1. For example, the ARRC 41 may extract SLAM-related information, such as generating a map for a physical environment unknown to ARRC 41. The ARRC 41 may further perform the semantic perception of the unknown physical environment to detect and recognize one or more POs. For example, based on AR resource(s) shared by ARRP 42 (e.g., ARD-2 ), ARD-1 may dynamically transform an unknown physical environment into a known or at least a familiar physical environment. For example, the physical world knowledge information may further be delivered (e.g., transmitted) to the AR application (ARA) 412 associated with the ARRC 41, which may perform dynamic and customized AR scene design for the unknown physical environment, based on the shared physical world knowledge. In the example of Type-2 sharing, the physical world knowledge may be extracted by ARRP 42, such that the ARP of the ARRC 41 may/might not perform any knowledge extraction.

The AR Processor of ARRC 41 may realize a designed AR scene output by the ARA 412. For example, the ARA 412 may deploy a designed AR scene for rendering such that the AR processor may generate an AR effect for the user of the ARRC 41. For example, after the ARRC 41 may have arrived at a physical environment X, e.g., a target location (e.g. location B), its own built-in camera may (e.g., start to) capture video frames, which may be sent to the AR Processor of ARRC 41. The AR Processor of ARRC 41 may quickly re-locate or validate the existence of the PTO(s) in its own video frames based on the physical world knowledge about this physical environment (which may have been received from ARRP 42). For example, the AR processor of ARRC 41 may estimate the ARRC's camera pose (e.g., any of position and orientation) and may perform one or more calibrations, in order to superimpose VOs to the physical world. For example, the AR processor of ARRC 41 may perform rendering to deliver the AR effect to the physical viewport of the user of ARRC 41.

In an example, the ARRC 41 may include an ARA 412. Embodiments described herein focus on the ARA 412 associated with the ARRC, which may be the consumer of shared AR-related resources, such as physical world knowledge. The AR application may perform dynamic (e.g., online) and customized AR scene design e.g., based on application logic. For example, the AR application may receive the physical world knowledge about an unknown physical environment and may generate a customized AR scene. Such an AR scene may further be deployed to the AR Processor of the ARRC 41 for realization (e.g., rendering) in order to present the AR effect to the user of the ARRC 41 as the ARRC 41 may be traveling in the new (previously unknown) physical environment at a later time.

FIG. 4 describes basic AR device functional architectures of ARRP 42 and ARRC 41. ARRP 42 and ARRC 41 may be considered as an individual WTRUs having the communication capability to interact with other WTRUs.

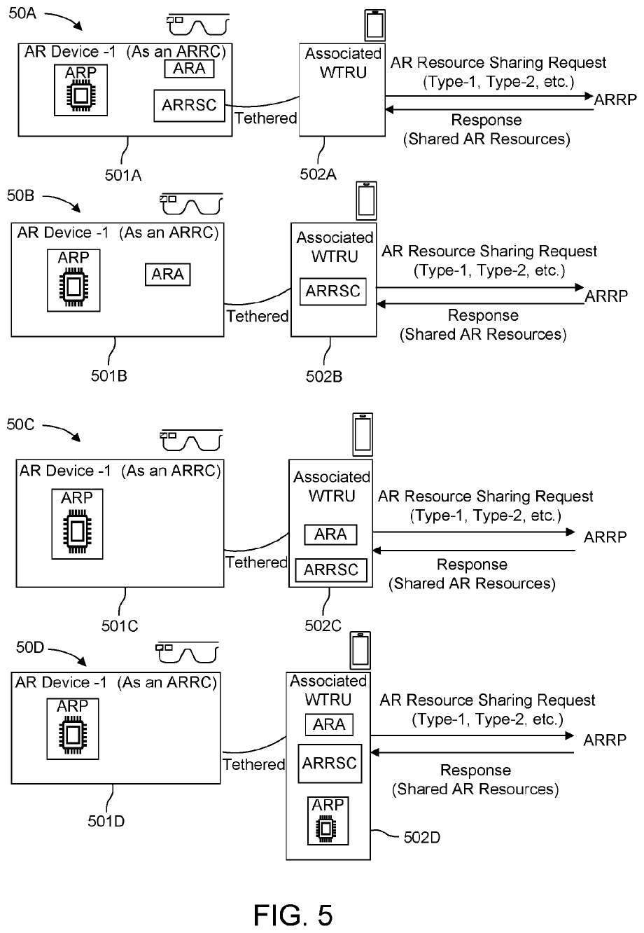

FIG. 5 is a diagram illustrating four examples of AR device functional architectures of ARRC. In the four examples of architectures 50A, 50B, 50C, 50D the ARD (as ARRC) may comprise a first part that may/might not have the capability to (e.g., directly) communicate with the ARRP. The first part of the ARD (as ARRC) may be, for example, associated with a second part such as e.g., a WTRU (e.g., a smartphone). For example, the ARD may comprise an AR glass that may rely on an associated smartphone to communicate with the other entities (e.g., an ARRP). For example, in the first architecture 50A, the associated WTRU 502A may provide communication support for the first part 501A of the ARD (as ARRC), which may comprise an ARP, an ARA and an ARRSC. In the second architecture 50B, the ARP and ARA may be hosted by the first part 501B of the ARD (as ARRC) and the ARRSC may be hosted on the associated WTRU 502B. In the third architecture 50C (e.g., only) the ARP may be hosted on the first part 501C of the ARD (as ARRC). The ARRSC and ARA may be hosted on the associated WTRU 502C. In the fourth architecture 50D, ARA and ARRSC may be hosted on the associated WTRU 502D and the first part 502D of the ARD (as ARRC) may (e.g., only) host the ARP. For example, the associated WTRU 502D may (e.g., also) host an ARP. For example, the ARP hosted on the associated WTRU 502D may be more powerful than the ARP hosted by the first part 501D of the ARD (as ARRC).

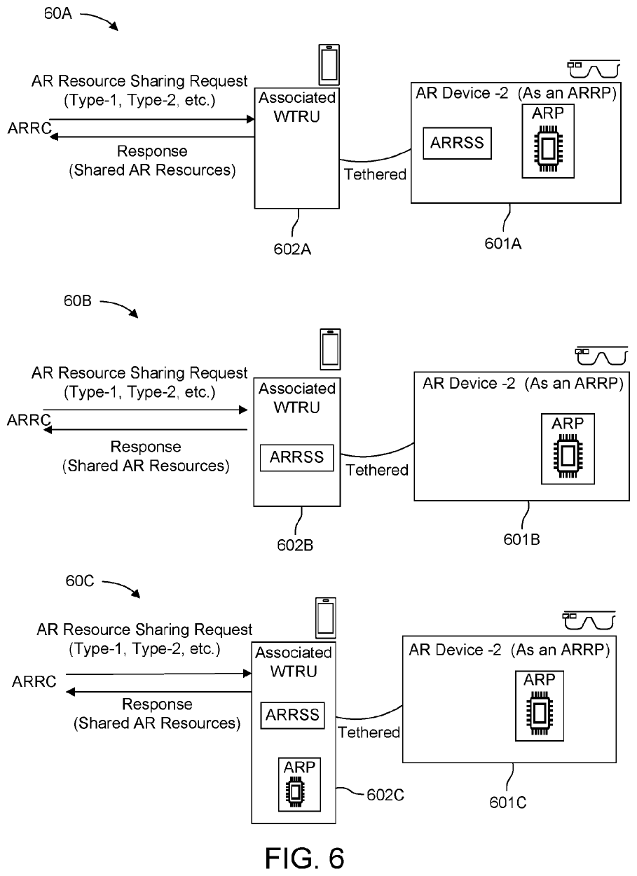

FIG. 6 is a diagram illustrating three examples of AR device functional architectures of ARRP. In the three examples of architectures 60A, 60B, 60C, a first part of the ARD (as ARRP) may/might not have the capability to (e.g., directly) communicate with ARRC. For example, the first part of the ARRP may be associated with a second part such as e.g., a WTRU (e.g., a smartphone). For example, the first part of the ARD may be an AR glass that may rely on the associated smartphone to communicate with the other entities (e.g., ARRC). For example, in the first architecture 60A the associated WTRU 602A may (e.g., only) provide the communication support for the first part 601A of the ARD (as ARRP), which may host the ARRSS and the ARP. In the second architecture 60B the ARP may be hosted on the first part 601B of the ARD (as ARRP) and the ARRSS may be hosted on the associated WTRU 602B. In the third architecture 60C, the ARRSS may be hosted on associated WTRU 602C, and the first 601C part of the ARD (as ARRP) may (e.g., only) host the ARP. For example, the associated WTRU 602C may (e.g., also) host an ARP. For example, the ARP hosted on the associated WTRU 602C may be more powerful than the ARP hosted by the first part 601C of the ARD (as ARRP).

### Example of Cross-User Collaboration Relationship Establishment Between ARRP and ARRC

For obtaining AR resources (such as e.g., any of the original video frames and the extracted physical world knowledge) from an ARRP, an ARRC may (e.g., first) establish a collaboration and resource-sharing relationship with the ARRP.

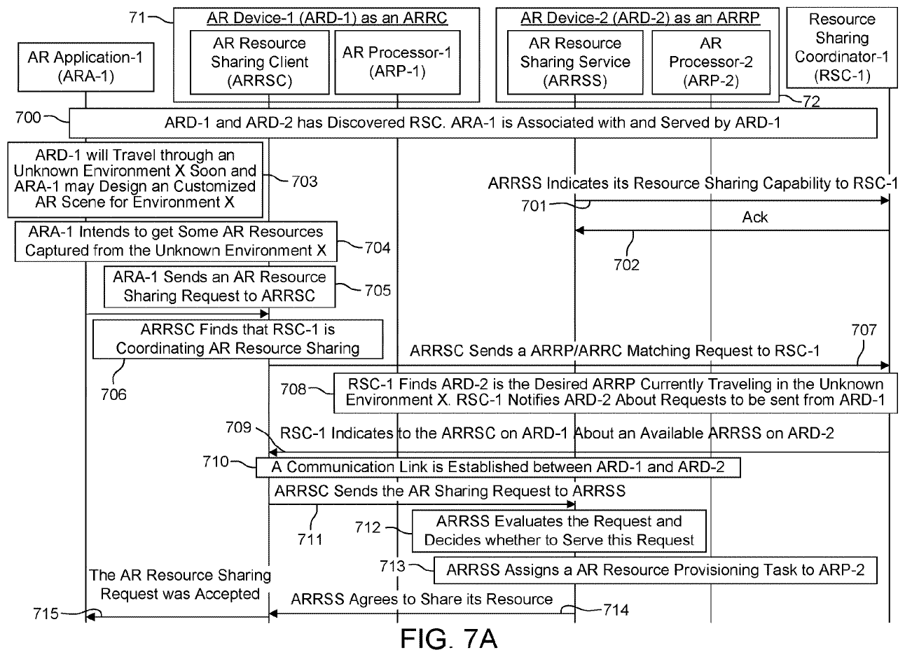

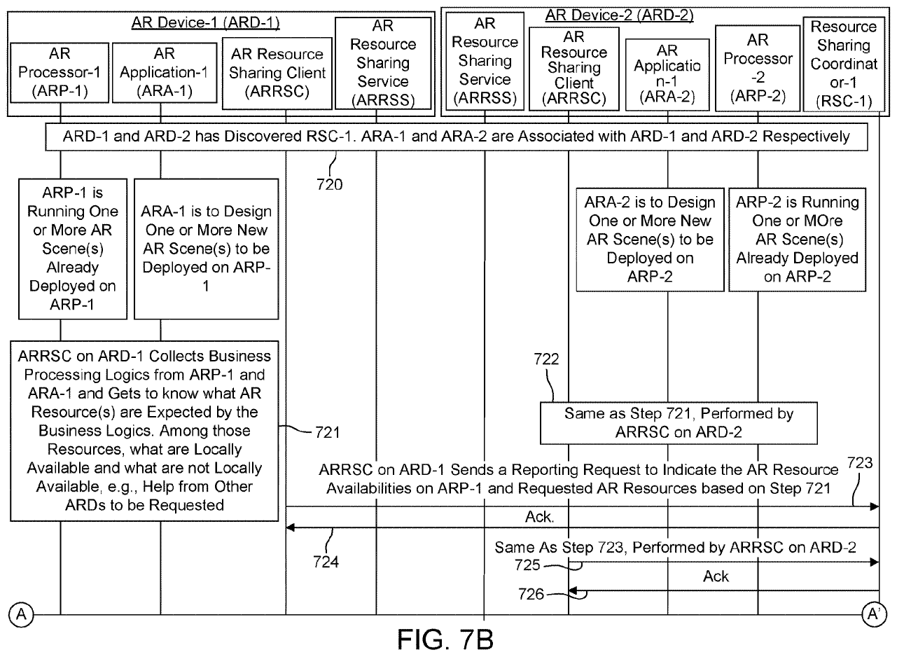

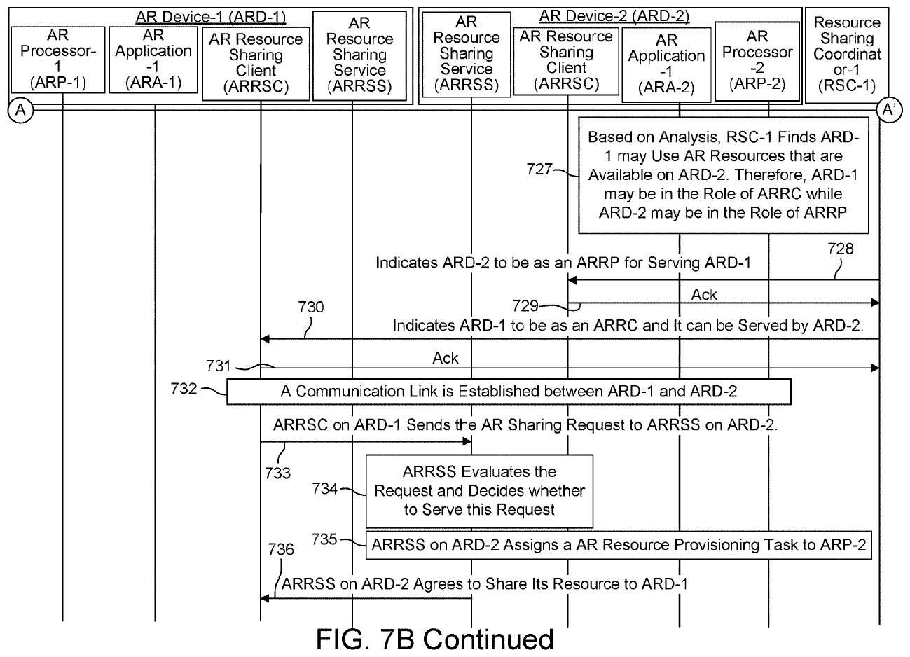

FIG. 7A is a diagram illustrating an example procedure for enabling cross-user collaboration relationship establishment. The procedure may depend on what kinds of (e.g., specific) AR resource(s) may be shared between ARRP and ARRC. For example, the parameters in one or more steps may be adjusted. For example, one ARRC may build one or more cross-user collaboration relationships with more than one ARDs (as ARRPs).

ARD-1 71 may be an AR device operating as an ARRC. ARA-1 may be an AR application associated with ARD-1. For example, based on application logic, ARA-1 may design an AR scene for serving the user of ARD-1 71 (e.g., Lisa as discussed in the use case illustrated in FIG. 3). ARD-2 72 may be another AR device, operating as an ARRP, which may be carried by (e.g., associated with) a different user (e.g., Mike as discussed in the use case illustrated in FIG. 3).

As shown at 700, any of ARD-1 71 and ARD-2 72 may discover the RSC using any service discovery solution, such as e.g., based on any of the following examples.

In a first example, any of the ARRC and the ARA may be pre-configured with RSC information such as e.g., any of the fully qualified domain name (FQDN) and an IP address of the RSC.

In a second example, the user may know the contact address, such as e.g., any of the FQDN and the IP address of the RSC, such that the RSC information may be configured via a user interface of the ARDs.

In a third example, the RSC information may also be provisioned via mobile network operator (MNO) through any of 5GC and 6GC procedures. For example, RSC (e.g., configuration) information may be included in a message of any of a protocol data unit (PDU) session establishment procedure and a WTRU registration procedure.

In step 701, ARD-2 72 may be at location B on a street and may be moving towards location C. For example, ARD-2 72 may operate as an ARRP. For example, ARD-2 72 may comprise a corresponding ARRSS, which may serve AR resource-sharing requests received from one or more ARRCs. To advertise itself, (e.g., the ARRSS of) ARD2 may send AR capability information (e.g., such as e.g., a capability registration request) to a network element hosting RSC-1 to indicate its AR-related resource-sharing capabilities. The capability information may include any of an ARD identifier, an ARD role, a type of AR resources that may be shared, AR hardware resource capabilities, AR software capabilities and localization information associated with the ARD and a physical environment.

In an example, the ARD identifier may indicate the identifier of the ARD-2 72.

In an example, the ARD role may indicate what role(s) ARD-2 72 may be capable of acting (e.g., operating). In this example, ARD-2 72 may indicate it may operate as an ARRP. In other examples, an ARD may have (e.g., operate) more than one role at a time, e.g., ARRP and ARRC being logical roles. For example, ARD-2 72 may operate as an ARRP by sharing its AR resources with the ARD-1 71. At the same time, ARD-2 72 may (e.g., also) operate as an ARRC in a case where it expects to obtain AR resource(s) from a third ARD device. For the sake of simplicity, embodiments are described herein with ARD-2 72 operating as an ARRP. Embodiments described herein are not limited to ARD-2 72 operating (e.g., only) as ARRP.

In an example, the type of AR resources that may be shared may indicate the types of AR resources that ARD-2 72 may be capable of providing (e.g., of sharing). For example, in the Type-1 AR resource-sharing type, ARD-2 72 may indicate it may share its original video frames with one or more ARRCs. For example, ARD-2 72 may share (e.g., provide) AR resources of different types with different ARRCs. For example, ARD-2 72 may perform Type-1 sharing with ARD-1 71 (as described herein). At the same time, ARD-2 72 may (e.g., also) perform Type-2 sharing with a third ARD. For example, the AR resource sharing capability of ARD-2 72 may depend on any of its hardware capabilities, software capabilities, MNO provider, application provider, policy, and user preferences.

In an example, the AR hardware capabilities may indicate what kinds of AR-related hardware may be associated with ARD-2 72, such as the CPU capacity, memory (e.g., storage) capacity, the sensors installed on the ARD-2 72, such as inertial sensors (e.g., including any of accelerometers and gyroscopes), one or more cameras including any of RGB image capture camera, depth camera and light detection and ranging (LiDAR) camera, etc.

In an example, the AR software capabilities may indicate what kinds of AR software may be associated with (e.g., running on) ARD-2 72, such as e.g., any of (i) semantical perception capability e.g., using one or more artificial intelligence (AI) capabilities, such as object detection and recognition, to understand the physical world, (ii) simultaneous localization and mapping (SLAM) capability which may allow to create a map for unknown environments and to provide the localization of the device within that environment, and (iii) AR rendering. For example, AR software capabilities described herein may be running (e.g., be executed) on the ARP.

In an example, localization information associated with the ARD and a physical environment may indicate any of the current location of the ARD (e.g., in the physical environment), a (e.g., planned travel) path of the ARD (e.g., towards the physical environment) and an (e.g., average) moving speed of the ARD. The (e.g., planned travel) path of the ARD may, for example, indicate a direction. In case of (e.g., planned travel) path change, the ARD may send information to RSC-1 indicating (e.g., notifying) an updated planned travel path. Any of the current location, the path and the speed may allow RSC-1 to determine in which physical environment an ARD may be located, towards which physical environment the ARD may be moving, and when the ARD may leave/enter a physical environment.

In an example, in step 702, RSC-1 may record the AR resource-sharing capabilities registered (e.g., indicated) by ARD-2 72 for future usage and may send an acknowledgment to ARD-2 72. For example, in a case where ARD-2 72 changes one or more of its capabilities, it may send another (e.g., updated) capability information to RSC-1 e.g., based on steps 701 and 702.

In an example, ARA-1 may be an AR application for serving the user of ARD-1 and for designing customized AR scenes/experiences for the user.

In an example, in step 703, based on the business logic, ARA-1 may determine that ARD-1 71 may be going to travel through an unknown (e.g., new) environment X (such as the street between location B and location C), and ARA-1 may determine to provide an AR experience to the user traveling through environment X. Designing a customized AR scene for realizing the AR experience may be based on physical world knowledge about the unknown environment X which may/might not yet be available to ARA-1.

In an example, in step 704, to obtain up-to-date and accurate physical world knowledge about the physical environment X, ARA-1 may determine to request (e.g., some latest) AR-related resources describing the physical environment X.

In an example, in step 705 ARA-1 may send an AR resource-sharing request to ARRSC of ARD-1. ARRSC may be seen as module of ARD1 for identifying one or more AR-related resources. In a case where ARA-1 and ARRSC are hosted by different devices, ARA-1 and ARRSC may maintain some information (e.g., to build a connection) between them. For example, ARA-1 may be hosted by an associated smartphone and ARRSC may be hosted by an ARD. For example, ARA-1 may leverage the ARRSCs of one or more ARDs by maintaining the contact addresses of different ARRSCs. For example, the same ARRSC may (e.g., also) serve one or more ARAs by maintaining the contact address of different ARAs. In a case where ARA-1 and ARRSC are running on a (e.g., single) device, they may be implemented as a single module and may/might not exchange the AR resource-sharing request message described in step 705. For example, ARD-1 may (e.g., directly) send an ARRP/ARRC matching request 707 to RSC-1 .

In an example, any of an AR resource-sharing request and an ARRP/ARRC matching request may indicate any of one or more types of AR resource that may be requested, information associated with the AR resources that may be requested, and localization information associated with the ARD. The information associated with requested AR resources may depend on the type of resources that may be requested and will be described in more detail hereafter.

In an example, in the context of Type-1 sharing, a type of requested AR resource may indicate that the original video frames captured from environment X may be requested. Type-1 sharing may/might not be limited to video frame sharing and may be applicable, in a broader sense, to any kind of raw data that may be used as AR-related resources by ARA-1 , such as sensory data generated by any type of sensor, radar, etc. In the context of Type-2 sharing, the type of requested AR resource may indicate that physical world knowledge e.g., extracted from the video frames may be requested.

In an example, the information associated with requested AR resources may indicate any of characteristics, properties, and expectations associated with the requested AR resources.

In an example, the localization information associated with the ARD (e.g., ARD-1 71) may indicate any of the current location of ARD-1 71, the (e.g., planned travel) path of ARD-1 71, and the (e.g., average) speed of ARD-1 71. For example, considering that ARA-1 may intend to design an AR scene to be applied to the street between location B and location C, ARA-1 may intend to find an ARRP which may have an overlapped travel path and may provide valuable knowledge (e.g., AR resources) to ARA-1 for facilitating AR scene design by ARA-1. The average moving speed of ARD-1 (e.g., or associated ARA-1 ), along with the current location of ARD-1 may allow to indicate (e.g., to an ARRP) a level of emergency for the ARRC (e.g., ARD-1 ) to get the requested AR resources.

In an example, in step 706, the ARRSC may receive the AR resource-sharing request from ARA-1. The ARRSC may identify an ARRP that may be capable of serving the AR resource-sharing request. For example, the ARRSC on the ARD-1 may have (e.g., already) discovered RSC-1 and may be aware that RSC-1 may be capable of coordinating AR resource sharing between one or more ARRPs and one or more ARRCs.

In an example, (e.g., the ARRSC running on) ARD-1 71 may send information 707 (which may be referred to herein as any of an ARRP/ARRC matching request and an AR resource request) to a network element e.g., running an RSC (which may be referred to herein as RSC-1). The AR resource request 707 may include information indicating any of an identifier of ARD-1, a role of ARD-1, and any parameter indicated by an AR resource-sharing request as described for step 705. The role may indicate any of an ARRP role and an ARRC role. In this example, the role of ARD-1 may indicate that ARD-1 may be operating as an ARRP.

In an example, in step 708, RSC-1 may receive the ARRP/ARRC matching request 707 from (e.g., ARRSC on) ARD-1 71. For example, RSC-1 may check the registered ARRPs. For example, RSC-1 may determine that ARD-2 72 may be an ARRP capable of serving the request received from (e.g., ARRSC on) ARD-1 71 based on, e.g., determining that ARD-2 72 may be (e.g., currently) in the physical environment of interest, and e.g., moving from location B to location C. For example, RSC-1 may (e.g., also) send information to the ARRP (e.g., ARD-2 72) indicating that upcoming requests may be received from ARRC (e.g., ARD-1 71). For example, RSC-1 may send information to the ARRP (e.g., ARD-2 72) indicating any of the identifier of ARRC and characteristics (e.g., properties) associated with AR resources to be requested by the ARRC.

In an example, in step 709, (e.g., ARRSC on) ARD-1 may receive from RSC-1 an AR resource response, including, for example, first information for communicating with (e.g., an available ARRSS hosted by) ARD-2 72. For example, the first information may indicate how ARD-2 72 may be contacted for building (e.g., establishing) a connection. First information for communicating with ARD-2 72 may indicate how ARD-2 72 may be contacted (e.g., by ARD-1 71) according to any of the following two examples.

In a first example, the first information may (e.g., directly) indicate the point of contact address of ARRP (such as e.g., the IP address of (e.g., the ARRSS of) ARRP), such that the ARRC may be able to (e.g., directly) contact, (e.g., send information to) the ARRP. Any other way to indicate a point of contact (e.g., any kind of address, identifier, etc.) may be applicable to embodiments described herein. The first example is illustrated in step 709 of FIG. 7A).

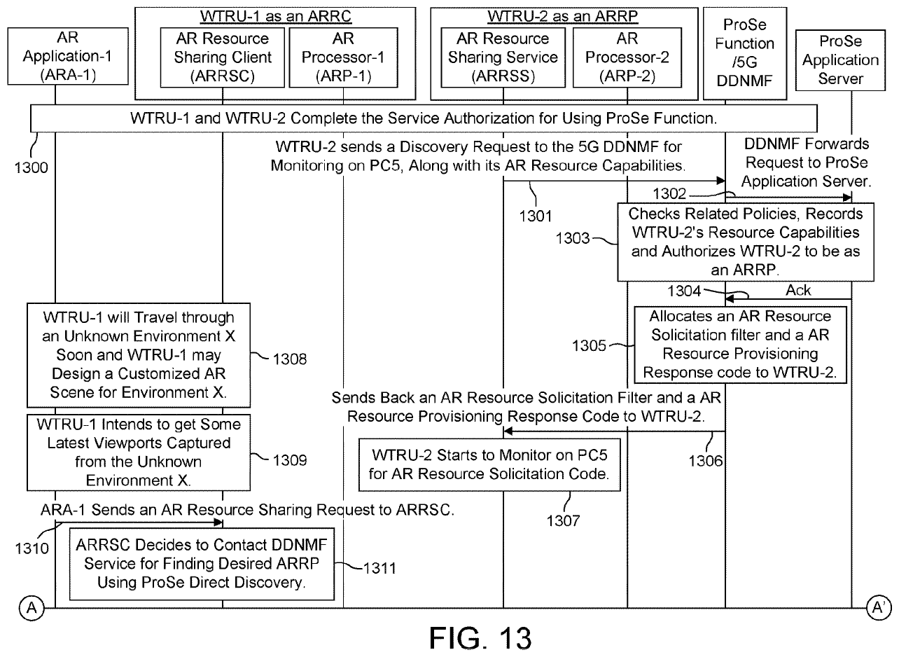

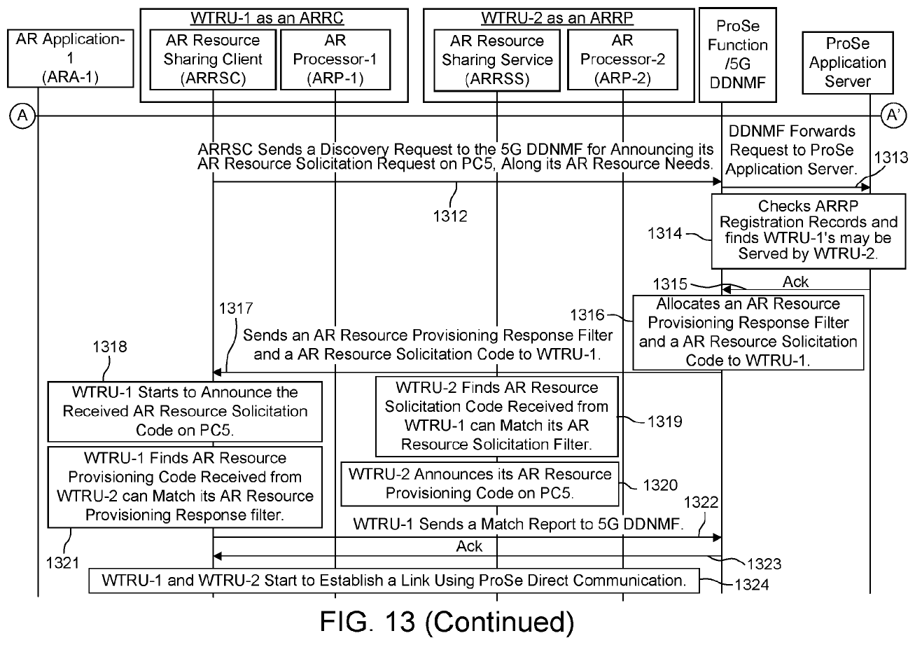

In a second example, a monitoring/announcing technique may be used. For example, by leveraging the 3GPP D2D direct discovery mechanism (such as e.g., Model B direct discovery mode), the ARD-1 as an ARRC may announce (e.g., transmit announcement information) on a (e.g., PC5) channel as a discoveree and ARD-2 as an ARRP may monitor ARRC's announcements as a discoverer such that ARD-1 and ARD-2 may retrieve (e.g., find) each other and may build a connection. The second example is illustrated in FIG. 13. Transmitting and monitoring announcement information on any kind of channel (e.g., not limited to 3GPP PC5 channel) may be applicable to embodiments described herein.

In an example, in step 710, ARD-1 71 may (e.g., start to) establish a communication link with ARD-2 72. For example, ARD-1 71 may build a device-to-device (D2D) communication link with ARD-2 72 based on the information e.g., indicated by RSC-1. Any other technique for establishing a communication link between ARD-1 71 and ARD-2 72 are applicable to embodiments described herein. In a case where ARD-1 71 does not have cellular communication capability and is associated with another WTRU having cellular communication capability (for example, Lisa may carry a smartphone and AR glasses and Lisa's AR glasses may communicate with other AR glasses via her smartphone, e.g., the AR glasses may be a tethered ARD), ARD-1 71 may rely on the associated smartphone to build a communication link with the ARD-2 72.

In an example, after the communication may have been established, (e.g., ARRSC on) ARD-1 71 may send an AR resource sharing request 711 to the (e.g., ARRSS on) ARD-2 72. For example, the AR resource sharing request 711 may include any of the parameters included in (e.g., indicated by) the AR resource request 707.

In an example, in step 712, (e.g., ARRSS on) ARD-2 72 may evaluate the AR resource sharing request 711 and may determine whether to serve this request. For example, the (e.g., ARRSS on) ARD-2 72 may consider (e.g., determine whether to serve this request based on) any of the AR hardware and software capabilities of ARD-2 72, localization information associated with ARD-2 72 (e.g., any of the current location of ARD-2 72, planned travel path of ARD-2 72), (e.g., current and anticipated) resource loading on ARD-2 72, MNO (or application) policy, and user preferences, etc.

In an example, in step 713, in a case where (e.g., ARRSS on) ARD-2 72 determined to serve the AR resource sharing request 711, an AR resource provisioning task may be created and assigned to ARP-2 on ARD-2 72. For example, ARP-2 may be instructed with detailed information e.g., about when and how to produce (e.g., collect, generate) the AR resources to be shared with ARRC. For example, the ARRSS may indicate (e.g., alert) the user of the ARD-2 72 (e.g., via a user interface) that the ARD-2 72 may capture video frames between location B and location C for sharing with another ARD such that the user may cooperate accordingly. The camera pose (e.g., position and/or orientation) may be determined by movement of the user of ARD-2 72. In a case where the user is willing to share the AR resources, the user may like to stick to his/her current planned path.

In an example, in step 714, (e.g., ARRSS on) ARD-2 72 may determine (e.g., agree) to provide and share one or more AR resources with the (e.g., ARRSC on) ARD-1 71. For example, ARD-1 71 may transmit an AR sharing resource response indicate any of the following information:

An AR sharing resource response may indicate one or more type(s) of AR resources to be shared by ARD-2 72.

An AR sharing resource response may provide any information detail about how the AR resources may be shared by ARD-2 72, such as e.g., QoS related information, resource availability schedule information, any constraints, etc.

An AR sharing resource response may indicate any policy or rule that ARD-2 72 may request (e.g., expect) ARD-1 71 to conform with.

For AR resource delivery (e.g., transmission), ARD-2 , 72 may operate according to any of the following examples. In a first example, the ARRP may (e.g., directly, autonomously) deliver (e.g., transmit) the requested AR resources to ARRC. In a second example, ARD-1 71 may perform (e.g., send information indicating) a subscription to ARRP. In a case where ARRP has the video frames requested (e.g., subscribed) by ARRC, ARRP may send one or more notifications to ARRC indicating that ARRC may further fetch those video frames from the ARRP.

In an example, in step 715, (e.g., the ARRSC on) ARD-1 71 may indicate to ARA-1 that the AR resource-sharing request may have been accepted.

The procedure described herein may be seen as an on-demand approach for ARRC (e.g., ARD-1 ) to find an ARRP via RSC. In another example, the RSC may (e.g., proactively) push notifications (e.g., information) to ARRC indicating any availability of ARRP(s). For example, ARD-1 and RSC may communicate (e.g., over a connection) such that ARD-1 may (e.g., periodically, repeatedly) transmit information to RSC indicating any localization information update (e.g., any of current location and planned travel route). For example, RSC may be implemented by or co-located with an ARA server. Based on the localization information update, the RSC may (e.g., proactively) push (e.g., transmit) a notification (e.g., information) indicating the availability of ARD(s) in a physical environment X (which may also operate as ARRPs) to ARD-1. The notification (e.g., information) delivered to the ARRC may include some detailed sampled data about ARRPs. For example, the video frames captured from the candidate ARRPs may be included in the notifications and sent to the ARRC (e.g., ARD-1). For example, the user of ARD-1 may evaluate those sampled data to determine (e.g., select) an ARRP among the candidate ARRPs to collaborate with.

In the example described herein based on FIG. 7A, ARD-2 may register with RSC-1 as an ARRP and ARD-1 may register with RSC-1 as an ARRC. ARRP and ARRC being logical roles, one (e.g., physical) ARD may operate (e.g., both) roles at the same time.

FIG. 7B is a diagram illustrating another example procedure for enabling cross-user collaboration relationship establishment. The example illustrated in FIG. 7B differs from the example illustrated in FIG. 7A in that, a (e.g., each) ARD may send information indicating its AR business logic to RSC-1 and that business logic may indicate at which time the ARD may request which kinds (e.g., type(s)) of AR resources (if not locally available), and at which time the ARD may provision which kinds (e.g., type(s)) of AR resources (e.g., for serving other ARDs). For example, RSC-1 may learn and analyze business logic associated with the ARDs, and may dynamically assign roles (e.g., any of ARRP and ARRC) to different ARDs such that paired ARRP and ARRC may (e.g., start to) build a collaboration relationship with each other.

In an example, in step 720, ARD-1 and ARD-2 may have discovered RSC-1. A physical ARD may operate as any of (e.g., both) an ARRP and an ARRC. A physical ARD may comprise (e.g., run) an ARRSC and an ARRSS. For example, ARD-1 may use its ARRSC to interact with other network elements (e.g., ARDs) in a case where ARD-1 is operating as an ARRC and ARD-1 may use its ARRSS in a case where ARD-1 is operating as an ARRP for providing one or more AR resources to other ARDs. For example, ARA-1 and ARA-2 may be associated with ARD-1 and ARD-2, respectively. ARA-1 and ARA-2 may comprise AR applications for designing customized AR scenes. The designed AR scene(s) may be further deployed to corresponding ARPs for execution. For example, for ARD-1, ARP-1 may be running one or more AR scene(s) deployed on ARP-1, and for ARD-2, ARP-2 may be running one or more AR scene(s) deployed on ARP-2). For example, ARA-1 and ARA-2 may have (e.g., new) tasks to design one or more new customized AR scene(s). In this setup, the ARAs (ARA-1 or ARA-2) may request one or more AR resources for facilitating its customized AR scene design, such as e.g., any of video frame resources, physical world knowledge resources, etc. For example, ARPs (ARP-1 and ARP-2) may provision (or consume) one or more AR resources. For example, the ARPs may capture video frames from any of the built-in cameras of the ARDs and those video frames may be shared with other ARDs. For example, ARPs may process the video frames and generate physical world knowledge and may share that knowledge with other ARDs. For example, an ARP may (e.g., also) benefit from one or more additional AR resources for boosting its AR processing for executing (e.g., rendering) the deployed AR scenes. For example, such AR resources may comprise general resources, such as computing resources in a case where the ARP currently lacks sufficient computing resources and may request assistance from other ARDs (e.g., to offload some AR computing (e.g., processing) tasks to other ARDs), etc.

In an example, in step 721, (e.g., ARRSC on) ARD-1 may collect business processing logic from any of ARP-1 and ARA-1. For example, the business processing logic may allow to indicate any of the following pieces of information:

In a first example, the business processing logic may indicate any of the computing and storage capacities of ARD-1.

In a second example, the business processing logic may indicate localization information associated with ARD-1 , such as e.g., any of (e.g., planned travel) path, travel speed, and current location.

In a third example, the business processing logic may indicate one or more AR scenes that may currently be deployed and executed by ARP-1. For example, in a case where ARP-1 is rendering an AR scene, its camera may be capturing video frames from the real world, which may be a type of AR resource that may be of interest for other ARDs. For example, by analyzing the planned travel path information, the ARRSC may understand what kinds of AR resources may be provisioned by ARD-1 (e.g., for now and for the future). For example, future locations may be estimated based on the planned travel path. For example, in a case where ARD-1 is moving towards location X, the ARRSC may determine that ARP-1 may provide video frames about location X e.g., soon. In addition to provisioning AR resources for other ARDs, the ARRSC may determine what (e.g., kinds of AR) resources may be used by (e.g., provided to) ARP-1 for facilitating its AR processing. For example, in a case where such resources are already locally available to ARD-1, ARP-1 may use them. In a case where such resources are not locally available, ARP-1 may obtain (e.g., request) AR resources from other ARDs. For example, the ARRSC may estimate any of the current and future workload of ARP-1 based on ARD-1's computing and storage capacities. For example, the ARRSC may estimate that more computing resources may be obtained from other nearby ARDs when ARD-1 may be moving to location Y later. For example, ARP-1 may/might not be run any AR scene, e.g., in idle status, and may capture video frames from any of its built-in cameras and may provision (e.g., be able to provide) AR resources to other ARDs.

In a fourth example, the business processing logic may indicate new AR scene(s) to be designed by ARA-1. For example, to design new AR scene(s), ARA-1 may request one or more AR resources. For example, based on ARD-1's current location and/or planned travel path, the ARRSC may estimate what kinds of AR resources may be used by ARA-1 for now and for future usage. For example, in a case where such AR resources are already locally available, ARP-1 may use them, and in a case where such AR resources are not locally available, ARP-1 may obtain the (e.g., desired) AR resources from other ARDs.

In an example, in step 722, (e.g., ARRSC on) ARD-2 may operate as (e.g., ARRSC on) ARD-1 in step 721.

In an example, in step 723, (e.g., ARRSC on) ARD-1 may send a reporting request to RSC-1, indicating any of the AR resource availabilities on ARP-1 and one or more requested AR. For example, the reporting request may include any piece of information indicated by the business processing logic information described in step 721. For example, the reporting request may comprise the original business logic information which may be analyzed by RSC-1 to determine what kind of resources may be available at ARD-1 (at what time) and what kinds of resources may be requested by ARD-1 (at what time, etc.). In another example, such an analysis may be performed by ARD-1 itself. For example, the reporting request may comprise information resulting from the analysis of the business logic information, as described herein, allowing to reduce the workload of RSC-1.

In an example, in step 724, RSC-1 may send an acknowledgment to (e.g., ARRSC on) ARD-1 .

In an example, in step 725, (e.g., ARRSC on) ARD-2 may operate as (e.g., ARRSC on) ARD-1 in step 723.

In an example, in step 726, RSC-1 may send an acknowledgment to (e.g., ARRSC on) ARD-2 .

In an example, in step 727, RSC-1 may analyze the business logic information received from ARDs (e.g., ARD-1) and may determine what kind of resources may be available at ARD-1 (at what time) and what kinds of resources may be requested by ARD-1 (at what time, etc.). Based on the analysis, RSC-1 may (e.g., dynamically) pair different ARDs and may assign different roles (e.g., ARRP and/or ARRC) to them. For example, RSC-1 may determine that ARD-1 may use one or more AR resources, which may/might not be locally available at ARD-1. RSC-1 may determine that one or more AR resources may be available on ARD-2. RSC-1 may pair ARD-1 with ARD-2 and may determine that ARD-1 may operate as an ARRC, and that ARD-2 may operate as an ARRP. For example, ARD-1 and ARD-2 may help each other, e.g., mutual assistance (e.g., AR resource provisioning) may be performed. In that example, in the pairing relationship, ARD-1 and ARD-2 may operate in (e.g., both) roles, e.g., ARRP and ARRC.

In an example, in step 728, RSC-1 may send first information to ARD-2 indicating that ARD-2 may be paired with ARD-1 and that ARD-2 may operate as an ARRP for serving ARD-1. The first information may further indicate any additional parameter describing AR resources that may be requested by ARD-1 according to any embodiment described herein.

For example, in step 729, ARD-2 may send an acknowledgment to RSC-1, indicating an agreement of ARD-2 to operate as an ARRP for ARD-1 and to be contacted by ARD-1.

In an example, in step 730, RSC-1 may send second information to ARD-1, indicating that ARD-1 may be paired with ARD-2 and that ARD-1 may operate as an ARRC for obtaining one or more AR resources from ARD-2. The second information may further indicate how ARD-1 may contact or build a connection with ARD-2. For example, any of the following two techniques may be followed to contact ARD-2 .

In a first example of technique, the RSC-1 may transmit information to the ARRC indicating the point of contact address of the ARRP (such as e.g., the IP address of the (e.g., ARRSS of) ARRP), such that the ARRC may (e.g., directly) contact the ARRP (the first example of technique is illustrated with FIG. 7A).

In a second example of technique, a monitor/announce technique may be used. For example, by leveraging the 3GPP D2D direct discovery mechanism (e.g., Model B direct discovery mode), the ARRC may transmit information on the PC5 channel announcing the ARRC as a discoveree and the ARRP may monitor ARRC's announcement as a discoverer such that ARRC and ARRP may find each other and build a connection (the second example of technique is illustrated in FIG. 13).

In an example, in step 731, ARD-1 may send an acknowledgment to RSC-1 indicating an agreement to operate as an ARRC and may (e.g., be initiated to) contact ARD-2 .

In an example, in step 732, a communication link may be established between ARD-1 and ARD-2 .

In an example, (e.g., ARRSC on) ARD-1 may send an AR resource sharing request 733 to (e.g., ARRSS on) ARD-2. The AR resource sharing request 733 described with FIG. 7B may correspond to AR resource sharing request 711 described with FIG. 7A.

In an example, in step 734, (e.g., ARRSC on) ARD-2 may evaluate the request and may determine whether to serve this request. Step 734 may correspond to step 712 described with FIG. 7A.

In an example, in step 735, (e.g., ARRSS on) ARD-2 may assign an AR resource provisioning task to ARP-2. Step 735 may correspond to step 713 described with FIG. 7A.

In an example, in step 736, (e.g., ARRSS on) ARD-2 may transmit information to ARD-1 indicating an agreement to share the requested AR resource with ARD-1. Step 736 may correspond to step 714 described with FIG. 7A.

### Example of Type-1 Original Video Frame Sharing

In Type-1 sharing, an ARRC may obtain the original AR resource captured in an (e.g., unknown) physical environment, which may be shared by an ARRP having knowledge of that physical environment. Embodiments are described herein with the example of video frames as the (e.g., original, raw) AR resource to be shared. Embodiments described herein are not limited to video frames as (e.g., original, raw) AR resource, and may be used for sharing any type of (e.g., original, raw) AR resource provided by ARRP, such as sensory data generated by various sensors (e.g., radars) available on ARRP, audio, etc.

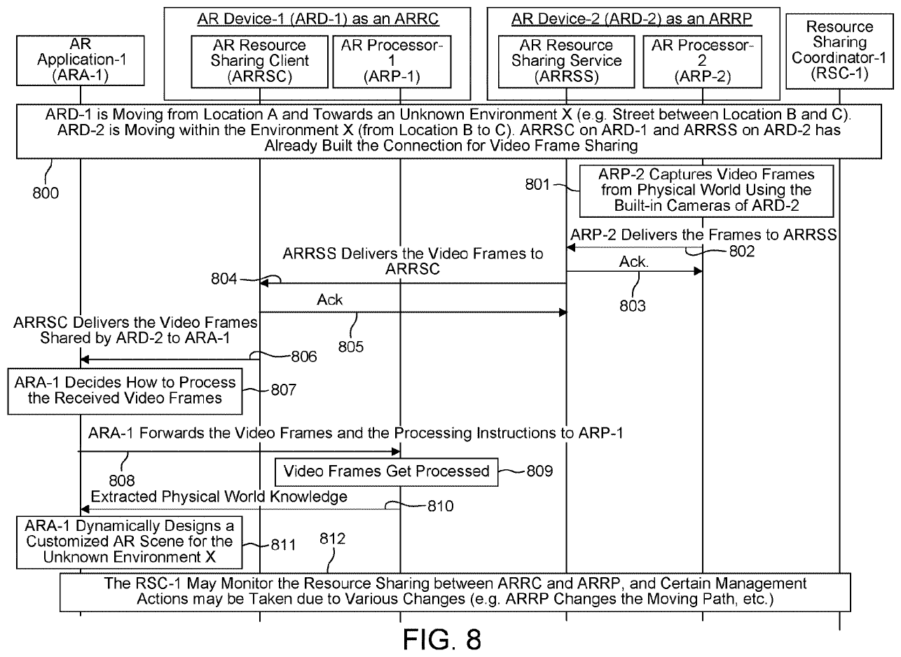

FIG. 8 is a diagram illustrating an example procedure for enabling original video frame sharing. In an example, (e.g., ARRSC on) ARD-1 and (e.g., ARRSS on) ARD-2 may have established a collaboration relationship and established a communication connection using e.g., the procedure described in FIG. 7A and/or FIG. 7B. For example, ARP-2 may have been assigned with an AR resource provisioning task for serving (e.g., ARRSC on) ARD-1 (as described in step 713 of FIG. 7A). In this example, the AR resource to be shared may comprise one or more original video frames of ARD-2.

In an example, in step 800, ARD-1 may be moving at location A towards an (e.g., unknown) physical environment X, such as e.g., the street between location B and location C. For example, ARD-2, as an ARRP, may be located in the physical environment X, e.g., moving between locations B and location C.

The procedure for collaboration relationship establishment between ARRP and ARRC illustrated in FIG. 7A and/or FIG. 7B may be adapted to be used for this example. For example, as ARRP and ARRC may be establishing the collaboration relationship, the following two parameters, included in step 705 (e.g., in the AR resource sharing request 707) as described in FIG. 7A may be adjusted as follows:

The parameter indicating the one or more types of AR resources that may be requested (e.g., by ARA-1) may indicate a Type-1 type, e.g., that one or more original video frames captured by ARRP may be requested as AR resources.

The information associated with the requested AR resources may indicate any of the following parameters.

In a first example, information associated with the requested AR resources may include any geographical information indicating (e.g., describing) a physical environment X (e.g., the street between location B and location C), from which the ARRP may be requested to capture video frames.

In a second example, information associated with the requested AR resources may indicate a frame capture frequency, which may indicate how fast the built-in camera of ARRP may be requested to capture the video frames from the physical environment X. For example, the camera may capture one image every three seconds.

In a third example, information associated with the requested AR resources may indicate a quality or resolution of the video frame, which may indicate what kind of quality of video frames may be requested by ARRC. Based on this information, ARRP may determine what types of built-in cameras may be used to capture the images.

In a fourth example, information associated with the requested AR resources may indicate a camera pose preference, which may indicate a preference for the camera pose of the ARRP when capturing video frames. For example, the ARRC may expect (e.g., request) the ARRP to take high-quality zoom-in pictures of the buildings on both sides of the street. For example, the ARRP may change its camera pose from time to time in order to capture video frames expected (e.g., requested) by the ARRC.

In an example, in step 801, (e.g., ARP-2 of) ARD-2 may capture the requested video frames from the physical world based on any of the cameras of ARD-2 as ARD-2 may be moving between location B and location C. The (e.g., ARP-2 of) ARD-2 may do some pre-processing to reduce the sizes of the raw video frames. For example, in a case where the ARRC indicated that it is not interested in pedestrians/sky, the (e.g., ARP-2 of) ARD-2 may remove certain regions in one or more raw video frames to reduce some communication cost (e.g., overhead) for delivering those raw video frame(s) from ARRP to ARRC.

In an example, in step 802, (e.g., ARP-2 of) ARD-2 may deliver (e.g., transmit) the captured video frame(s) to ARRSS (e.g., on ARD-1). For example, the (e.g., ARP-2 of) ARD-2 may consecutively deliver the view frames to ARRSS based on a pre-configured capture frequency. In another example, the (e.g., ARP-2 of) ARD-2 may accumulate one or more video frames and may deliver e.g., transmit) them to ARRSS in a batch (e.g., burst) manner. For example, (e.g., ARP-2 of) ARD-2 may deliver the video frames to ARRSS, and include any of the following parameters:

In a first example, the video frames may be transmitted with information indicating a list of video frames captured by (e.g., ARP-2 of) ARD-2.

In a second example, a (e.g., each) captured video frame may be associated with information indicating any of (i) a size of the video frame, (ii) a pose of the camera, which may include any of the position and the orientation of the camera of ARRP, (iii) and sensors (e.g., camera) used for capturing these video frames. For example, a high-resolution image may be captured by a red, green, blue (RGB) image capture camera and an image with depth information may be captured by a depth camera.

In a third example, the video frame(s) may be transmitted with information indicating other types of sensory data that may be captured and shared.

In an example, in step 803, ARRSS (on ARD-2) may send an acknowledgment to ARP-2 for the received video frame(s).

For example, (e.g., ARRSS on) ARD-2 may deliver (e.g., transmit) the requested AR resource(s) 804 as (e.g., original, raw) video frame(s) to the (e.g., ARRSC on) ARD-1 based on the established communication link between ARD-1 and ARD-2. For example, the ARRSC on ARD-1 (as ARRC) may build cross-user collaboration relationships with multiple ARDs (as ARRPs). For example, during the collaboration relationship establishment stage, the ARD-1 may subscribe to more than one ARRPs. For example, in a case where ARRPs have the video frames requested by an ARRC, they may send notifications to the ARRC such that ARRC may further fetch those video frames from the ARRPs (that may have notified the ARRC).

In an example, (e.g., ARRSC on) ARD-1 may send an acknowledgment 805 to (e.g., ARRSS on) ARD-2 for the received AR resource(s) 804, such as e.g., the video frame(s) or any other AR resource(s).

In an example, in step 806, (e.g., the ARRSC on) ARD-1 may determine that those video frame(s) may be expected by ARA-1. For example, ARRSC may deliver the newly received video frame(s) shared by ARD-2 to ARA-1. In an example, ARRSC may send a notification to ARA-1 about (e.g., indicating) the newly available video frames.

In an example, in step 807, based on application logic, ARA-1 may process the received video frame(s) for extracting physical world knowledge. For example, ARA-1 may use those video frame(s) to detect PTO(s) in the physical environment X. In another example, ARA-1 may use those video frame(s) to conduct SLAM-related operations (e.g., generating a 3D map) to get to understand the physical environment X.

In an example, in step 808, ARA-1 may forward the video frame(s) to ARP-1 , along with the processing instructions on how to extract physical world knowledge. In an example, ARA-1 may only send (e.g., only send) the processing instructions to ARP-1 and may ask ARRSC to deliver the video frames to ARP-1 for processing.

In an example, in step 809, video frame(s) shared by ARD-2 may be processed by the ARP-1 on ARD-1 and physical world knowledge may be extracted. For example, the physical world knowledge may refer to (e.g., comprise, indicate) the semantic perception of the physical environment X via AI-enabled object detection and recognition (e.g., what the POs may be in the environment X, and what their characteristics may be, such as e.g., any of their 3D position, color, shape, orientation, brightness, natural features, etc.). For example, the physical world knowledge may refer to (e.g., comprise, indicate) the generated map information of the physical environment X.

In an example, in step 810, the extracted physical world knowledge may be returned to ARA-1 .

In an example, in step 811, based on the physical world knowledge about the physical environment X, ARA-1 may dynamically design a customized AR scene for the user of ARD-1. For example, later, after the user of ARD-1 may have entered the physical environment X, the designed AR scene may be executed or rendered to deliver a rich AR experience to the user. As described herein, designing an AR scene may involves two tasks:

In a first task, based on the physical world knowledge, ARA-1 may determine which detected POs may be the PTOs, that may be augmented with an AR effect.

In a second task, ARA-1 may design the customized AR effect for the PTO(s), which may comprise a) determining what kind of VO(s) may be superimposed to the PTO(s) (e.g., the VO(s) may be downloaded) and b) configuring any of VO(s)′ appearances and VO(s)′ behavior e.g., in case of a customized behavior.

In an example, in step 812, RSC-1 may monitor the video frame sharing between ARRC and ARRP, and one or more operations may be performed based on one or more changes. For example, in a case where the ARRP changes the moving path, the RSC-1 may identify another (e.g., qualified) ARRP for serving the ARRC. In another example, according to the received video frames, ARA-1 may evaluate the quality of received video frames and may notify the ARRP, e.g., in a case where an adjustment may be requested. For example, ARP-1 may dynamically determine which next video frames may be requested and may send a notification to ARD-2 indicating new AR resources properties (e.g., any of new camera pose, new resolution, etc.).

Embodiments are described herein based on implementation examples involving separate modules for an ARA, and ARRSC and an ARP. Embodiments may be applicable to other types of ARD implementations with e.g., a single module, in which case the messages/information flowing between the described modules of the ARD may/might not be used.

### Example of Type-2 Physical World Knowledge Sharing

In Type-2 sharing, an ARRC may intend to obtain, e.g., from an ARRP the physical world knowledge extracted from the AR resources (e.g., video frames), which may be captured by the ARRP. For example, a number of different procedures are described herein, depending on how the physical world knowledge may be leveraged by the ARRC.

### Example of Cross-User Collaborative AR Processing for Physical Object Detection and Recognition

The following scenario is described herein: ARA-1 may expect ARRP (e.g., ARD-2 ) to help it to detect and recognize one or more POs of interest in the (e.g., unknown) physical environment X (e.g., the street between location B and location C), which may be the PTO(s) to be annotated with one or more AR effects. Such information may be used by ARA-1 for designing a customized AR scene for the user of ARD-1. The AR scene may be executed when the user may be traveling in the physical environment X later. For example, during the cross-user collaboration relationship establishment stage (related to the AR resource sharing request 711 described in FIG. 7A), (e.g., ARA-1 on) ARD-1 may indicate to the ARRP (e.g., ARD-2) that ARD-1 may rely on the ARRP to detect and recognize one or more POs in the physical environment X by analyzing any of the video frames captured by the built-in camera of the ARRP and other types of AR resources. For example, (e.g., ARA-1 on) ARD-1 may (e.g., also) indicate to the ARRP that ARD-1 may rely on the ARRP to extract map-related information about the physical environment X so that ARD-1 may/might not create a map from scratch. For example, an accurate map may allow ARD-1 to accurately estimate the pose of its own camera such that the VOs may be (e.g., perfectly) superimposed in the physical world. Based on physical world knowledge sharing about a physical environment X (which may still be unknown to ARD-1), ARA-1 may understand and be familiar with the physical environment X in advance (e.g., what physical objects may be there) e.g., before ARD-1 may arrive at the physical environment X. For example, knowing the physical environment X in advance may allow ARA-1 to have more time to prepare and design a customized AR scene (which may be rendered to the user of ARD-1 when ARD-1 may be in the physical environment X later).

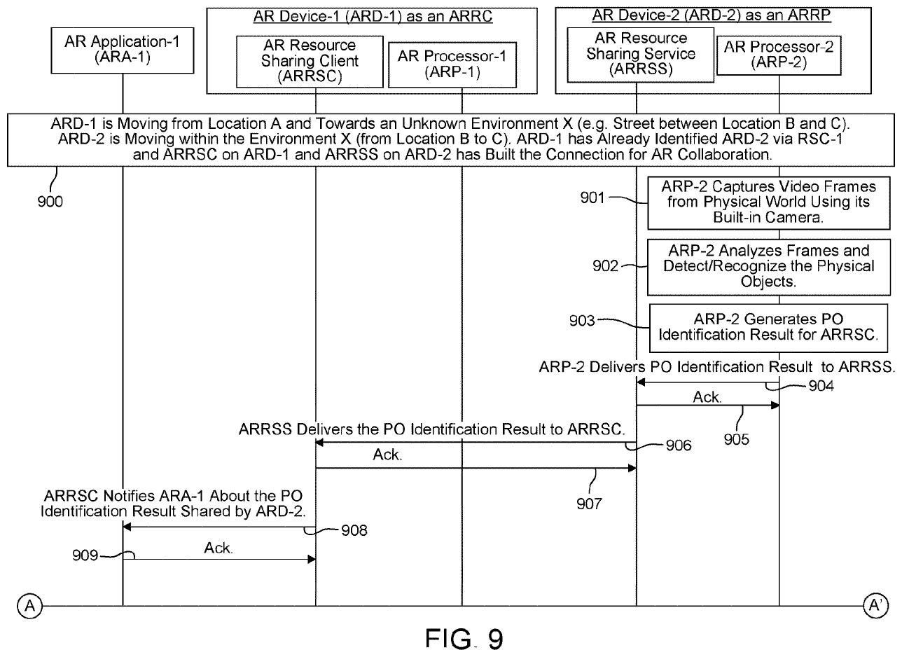

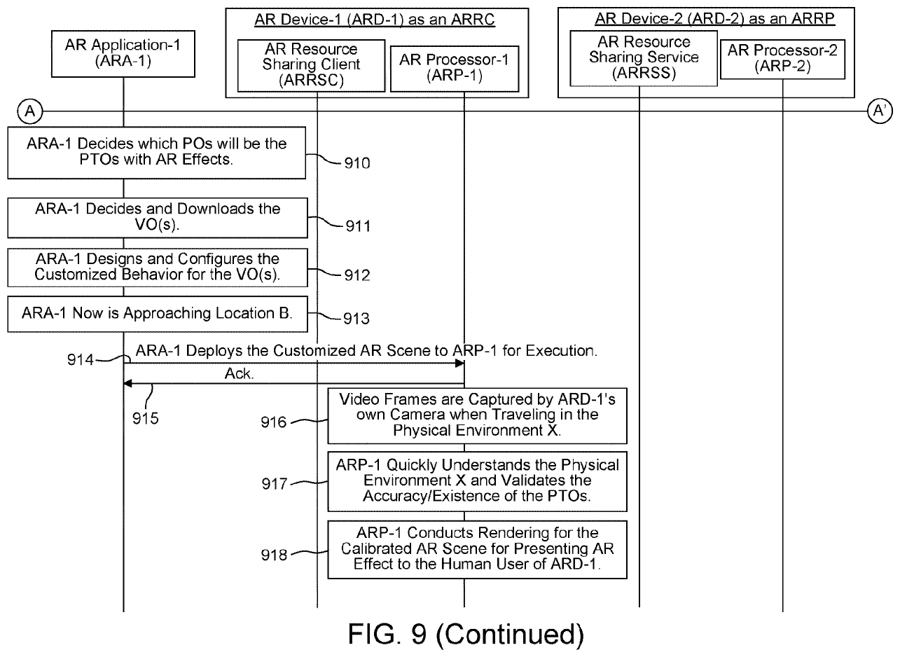

FIG. 9 is a diagram illustrating an example procedure for enabling physical world knowledge sharing for physical objection detection and recognition.

In an example, in step 900, ARD-1 may have identified ARD-2 via RSC-1 and (e.g., ARRSC on) ARD-1 and (e.g., ARRSS on) ARD-2 may have built the connection for AR collaboration. For example, ARP-2 may have been assigned an AR resource provisioning task during the collaboration relationship establishment stage (e.g., such as described in step 713 in FIG. 7A). In this example, the one or more AR resources to be shared may comprise the physical object identification result extracted from the one or more video frames captured by ARD-2. For example, ARD-1 may be located at location A and may be moving towards an (e.g., unknown) physical environment X, e.g., the street between location B and location C. For example, ARD-2, as an ARRP, may be located inside the physical environment X, e.g., moving between location B and location C.

For example, the procedure for collaboration relationship establishment between ARRP and ARRC as illustrated in FIG. 7A and/or FIG. 7B may be adapted to be used for this example. For example, as ARRP and ARRC may be establishing the collaboration relationship, the following two parameters included in step 705 (e.g., in the AR resource sharing request 707) as described in FIG. 7A may be adjusted as follows:

The parameter indicating the one or more types of AR resources that may be requested (e.g., by ARA-1 ) may indicate a Type-2 type e.g., the physical world knowledge about the physical environment X e.g., in terms of PO identification result. For example, ARA-1 may request ARD-2 to provide information about the map of physical environment X.

The information associated with the requested one or more AR resources may indicate a PO identification guideline, which may indicate, if a PO is identified by ARRP in the physical environment X, what kinds of information may be returned to the ARRC for describing this PO. For example, a PO identification guideline may indicate that the following information may be requested by the ARRC to describe a PO, including any of PO's 3D position, orientation, shape, color, brightness, moving speed, detection time, natural features (edge geometry, point cloud, etc.), etc.

In an example, in step 901, based on instructions of the assigned AR resource provisioning task (e.g., indicating when/how to provision/share AR resource(s) to ARRC), (e.g., ARP-2 on) ARD-2 may obtain (e.g., capture) the video frame(s) from the physical world using any of the built-in cameras of ARD-2 moving between location B and location C.

In an example, in step 902, (e.g., ARP-2 on) ARD-2 may analyze the video frame(s) to conduct semantic perception of the physical world. For example, (e.g., ARP-2 on) ARD-2 may detect and recognize one or more POs. For example, the (e.g., ARP-2 on) ARD-2 may (e.g., also) perform SLAM-related operations to generate a map (including the geometry and 3D models of the physical world) about the physical environment X.

In an example, in step 903, (e.g., ARP-2 on) ARD-2 may generate a PO identification result, which may be expected by (e.g., ARRSC on) ARD-1 and corresponding ARA-1.

In an example, in step 904, (e.g., ARP-2 on) ARD-2 may deliver the PO identification result to ARRSS.

In an example, in step 905, ARRSS may send an acknowledgment to ARP-2 for the received PO identification result.

In an example, (e.g., ARRSS on) ARD-2 may deliver (e.g., transmit) the AR resource(s) 906 as the PO identification result to the (e.g., ARRSC on) ARD-1. For example, for a (e.g., each) identified PO, the PO identification result may indicate any of a PO's 3D position, orientation, shape, color, brightness, moving speed, detection time, natural features (edge any of geometry, point cloud, etc.), etc. In another example, during the collaboration establishment stage, the (e.g., ARRSC on) ARD-1 may transmit information indicating what kinds of POs may be requested by performing a subscription to (e.g., ARRSS on) ARD-2. For example, the (e.g., ARRSS on) ARD-2 may send notifications to (e.g., ARRSS on) ARD-1 (e.g., only) in a case where one or more POs of interest are identified.

In an example, (e.g., ARRSC on) ARD-1 may send an acknowledgment 907 to (e.g., ARRSS on) ARD-2.

In an example, in step 908, ARRSC may notify ARA-1 about the PO identification result of the unknown physical environment X.

In an example, in step 909, ARA-1 may send an acknowledgment to ARRSC.

Steps 910-912 are related to how the ARA-1 may conduct a dynamic and customized AR scene design based on the received knowledge shared by ARD-2.

In an example, in step 910, ARA-1 may analyze the PO identification result and may determine which POs may be the PTOs that may be augmented with one or more AR effects. For example, the determination may be made based on one or more factors, such as e.g., any of a user preference, an implementation complexity, application logic, etc.

In an example, in step 911, after one or more PTOs may have been determined, one or more AR effects may be determined. For example, for a PTO, it may be determined what kinds of VO may be used to annotate this PTO. This process may be customized. For example, for a PTO, different users may like to use different VOs. For example, ARD-1 may/might not be able to store (e.g., all) the VOs locally (based on storage limitation). For example, ARA-1 may (e.g., proactively) initiate a VO retrieval process and may download the selected VO(s) in advance (e.g., before the ARD-1 may arrive in the physical environment X).

In an example, in step 912. After one or more VO(s) may have been determined and downloaded, ARA-1 may configure the appearances of the VO(s), such as any of their colors, brightness, etc. ARA-1 may further configure what kind of actions or behaviors the VO(s) may have.

Steps 913-918 are related to how ARD-1 may deploy and realize the customized AR scene designed by ARA-1 such that the AR effect may be displayed to the user of ARD-1 when ARD-1 may be moving in the physical environment X.

In an example, in step 913, e.g., later, ARA-1 may be approaching the physical environment X, e.g., approaching location B (as described in the use case illustrated in FIG. 3).

In an example, in step 914, ARA-1 may deploy the customized AR scene to ARP-1 for execution and rendering. For example, ARA-1 may indicate the following information to ARP-1.

In an example, the detailed AR scene may be indicated to ARP-1, which may include what kinds of PTOs may be annotated. For facilitating ARP processing, information about PTOs may be included, such as e.g., any of PTO's position, color, shape, geometry, orientation, images, etc. The detailed AR scene may further include information on how to annotate a (e.g., each) PO, e.g., use what VO. The detailed AR scene may further include the (e.g., full) file of VO asset, and its corresponding customized configuration details, such as any of PO's appearance, behavior design, etc.

In an example, ARA-1 may indicate to ARP-1 the appliable environment of the AR scene to be applied. This may indicate e.g., when to execute the AR scene. For example, an AR scene may be executed when the ARD is in the physical environment X. The physical environment X may be described using geographical positions and/or coordinates.

In an example, ARA-1 may indicate to ARP-1 one or more trigger(s) (e.g., conditions) for executing the AR scene. For example, referring to the example described herein where the physical environment X may refer to the street between location B and location C, based on GPS location information, a trigger (e.g., a condition) may be that the AR scene may start to be executed in a case where the ARD is located at location B.

In an example, in step 915, ARP-1 may send an acknowledgment to ARA-1 for the AR scene deployment.

In an example, in step 916, video frames may be captured by the (e.g., built-in camera of) ARD-1 itself in a case where ARD-1 may be located (e.g., and moving) in the physical environment X, e.g., the street between location B and location C.

In an example, in step 917, by leveraging the physical world knowledge received from ARD-2 (such as e.g., any of the PO identification result and the SLAM-related map information), ARP-1 may/might not start from scratch processing video frames and rendering the AR scene. For example, ARP-1 may understand the physical environment X more quickly in a case where the map information (e.g., physical world knowledge) was shared by ARRP. For example, ARP-1 may also use its own video frame(s) (captured by any of its own camera) to further enhance the accuracy of the map based on its own video frame(s) (captured by any of its own camera). For example, for the video frame(s) captured by ARD-1 itself, ARP-1 may reduce the time to validate the existence of the PTO(s) in those video frame(s) and the accuracy of the PTO identification result shared by ARD-2 (e.g., ARRP). In this way, ARP-1 may use a lover amount of time and computation resources to understand the physical environment X. For example, based on ARP-1 already knowing information about one or more PTOs (including any of 3D position, orientation, shape, color, natural features, etc.), ARP-1 may detect and locate this PTO in the current video frames captured by ARD-1 more rapidly (e.g., efficiently). For example, ARD-1 may comprise ranging (e.g., localization) capability to measure (e.g., determine) the geographical positions of the POs appeared in its current viewport). For example, the PTO identification result shared by ARD-2 may/might not be 100% accurate. Accordingly, the AR scene may be calibrated (e.g., adjusted).

In an example, in step 918, ARP-1 may use the (e.g., calibrated, adjusted) AR scene for rendering, e.g., based on the prepared VO(s) to annotate the PTO(s) appearing in the video frame(s) captured by ARD-1 via VO registration so that the AR effect may be displayed to the user of ARD-1.

Steps 910-918 described with FIG. 9 may be seen as a detailed description of step 811 described with FIG. 8. In an example, steps 910-918 may be applicable to the dynamic design of a customized AR scene based on received AR resource(s) as original video frame(s).

### Example of Cross-User Collaborative AR Processing for Knowledge Accuracy and Freshness Validation

The following scenario is described herein. ARA-1 may approach and may be arriving in the physical environment X soon. Based on application logic, ARA-1 may design a customized AR scene for the user of ARD-1 when ARD-1 may be moving in the physical environment X (e.g., the street between location B and location C). For example, ARA-1 may (e.g., already) have some knowledge about the physical environment X, such as e.g., any of a map of the physical environment X and the POs in that physical environment X. For example, ARA-1 may have downloaded the knowledge from a centralized world knowledge repository. In another example, ARD-1 may have traveled through the physical environment X at an earlier time, e.g., one month ago. In yet another example, ARD-1 may have received physical world knowledge information from another ARD having traveled through the physical environment X at an earlier time. For example, the physical world may keep changing, such that the physical world knowledge held by ARA-1 may/might not be valid or accurate, e.g., at least some of the knowledge may be out of date. For example, one or more PO(s), such as e.g., moving POs, may/might not exist anymore in the physical environment X. For example, the characteristics of a PO may (e.g., also) change from time to time (e.g., a window of a pizza shop may have a neon light during the nighttime, which may be different from its appearance during the daytime). For example, ARA-1 may use assistance of an ARRP to validate the accuracy and the freshness of the physical world knowledge currently held by ARA-1 such that up-to-date knowledge may be used for performing customized AR scene design.

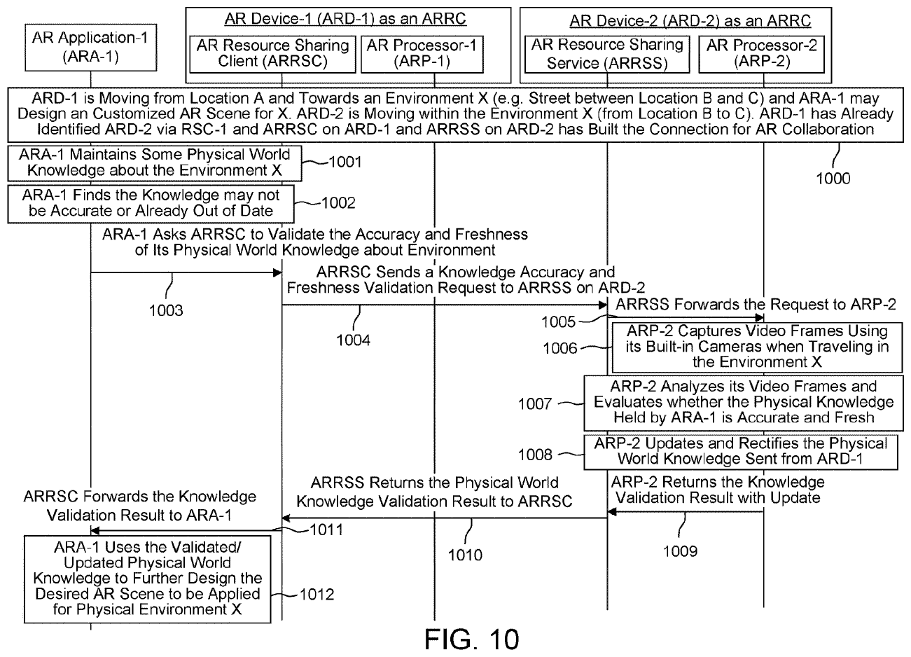

FIG. 10 is a diagram illustrating an example procedure for enabling physical world knowledge accuracy and freshness validation.

In step 1000, ARD-1 may be located at location A and may be moving towards a physical environment X (e.g., the street between location B and location C). ARD-2, which may be operating as an ARRP, may be located inside the physical environment X, e.g., moving between location B and location C. ARD-1 may have (e.g., already) identified ARD-2 via RSC-1 and (e.g., ARRSC on) ARD-1 and (e.g., ARRSS on) ARD-2 may have built a connection for AR collaboration using, for example, the procedure described in FIG. 7A and/or FIG. 7B. For example, ARP-2 may have been assigned an AR resource provisioning task during the collaboration relationship establishment stage (e.g., as described in step 713 of FIG. 7A). In this example, one or more video frames may be captured and shared by ARD-2 for the purpose of validating the accuracy and freshness of the physical world knowledge of ARD-1.

For example, the procedure for collaboration relationship establishment between ARRP and ARRC illustrated in FIG. 7A and/or FIG. 7B may be adapted to be used for this scenario. For example, as ARRP and ARRC may be establishing the collaboration relationship, the following two parameters, included in step 705 (e.g., in the AR resource sharing request 707) as described in FIG. 7A may be adjusted as follows:

The parameter indicating the one or more types of AR resources that may be requested (e.g., by ARA-1) may indicate that the accuracy and freshness validation result for the physical world knowledge held by ARRC may be requested.

The information associated with the requested AR resources may indicate a validation result format. For example, the information may indicate that if a PO's characteristics (e.g., any of position, shape, color, orientation, natural features, etc.) have changed, what kind of updated information may be requested, such as e.g., any of the updated position, shape, color, etc. For example, the information may also indicate that the ARRC may also request the ARRP to provide the latest close-up image of the PO.

In an example, in step 1001, ARA-1 may determine that there may some available knowledge stored locally about a physical environment X such as e.g., any of the characteristic information about POs in the physical environment X and a map about the physical environment X.

In an example, in step 1002, ARA-1 may determine that the knowledge about the physical environment X may/might not be accurate or may already be out of date. For example, ARA-1 may obtain (e.g., download) the knowledge from a knowledge repository and the knowledge may be tagged with an old (e.g., outdated) timestamp (indicating that the knowledge may already be stale). In another example, ARD-1 may have traveled through the physical environment X some (e.g., a long) time ago. To design an AR scene, ARA-1 may use an up-to-date and accurate knowledge of the physical environment X.

In an example, in step 1003, ARA-1 may ask ARRSC to validate the accuracy and freshness of its physical world knowledge about environment X.

In an example, (e.g., ARRSC on) ARD-1 may send a physical world knowledge validation request 1004 to (e.g., ARRSS on) ARD-2. For example, the physical world knowledge validation request 1004 may indicate a list of PO characteristic information to (e.g., ARRSS on) ARD-2. For example, for a PO, its characteristic information may indicate any of its position, shape, color, natural features, and orientation, which may already be known to the ARRC and may be validated by the ARRP. In another example, in a case where (e.g., ARRSC on) ARD-1 frequently asks (e.g., ARRSS on) ARD-2 for validating a list of POs, a versioning approach may be used. For example, for a (e.g., each) PO validation result sent from (e.g., ARRSS on) ARD-2 to (e.g., ARRSC on) ARD-1, the (e.g., ARRSS on) ARD-2 may attach (e.g., include, indicate) a version number to the PO validation result. For example, at a later time, the (e.g., ARRSC on) ARD-1 may (e.g., request to) re-validate whether the PO validation result currently held by the (e.g., ARRSC on) ARD-1 may (e.g., still) be fresh and/or accurate, the (e.g., ARRSC on) ARD-1 may indicate the version number of the PO validation result to the (e.g., ARRSS on) ARD-2 , and (e.g., all) the detailed characteristic information may/might not be re-sent for each PO in the PO list. This may allow to reduce the communication overhead. For example, in a case where the PO validation result held by the (e.g., ARRSC on) ARD-1 is fresh or accurate, the (e.g., ARRSS on) ARD-2 may reply (e.g., send information indicating) that the current version is valid. Otherwise, the ARRSS may return e.g., send information indicating) a new PO validation result to the (e.g., ARRSC on) ARD-1, and this new PO validation result may be associated with a new version number.

In an example, in step 1005, ARRSS may forward the physical world knowledge validation request to ARP-2.

In an example, in step 1006, ARP-2 may capture video frame(s) from the physical world using any of its built-in cameras e.g., as ARD-2 may be moving in the physical environment X, e.g., the street between location B and location C.

In an example, in step 1007, ARP-2 may analyze its video frame(s) and may check the physical world knowledge received from ARD-1. For example, ARP-2 may validate the existence and the status (e.g., characteristics) of POs as described (e.g., indicated) in the physical world knowledge received from ARD-1. For example, ARP-2 may (e.g., also) conduct a new round of SLAM to update the map of the physical environment X.

In an example, in step 1008, e.g., in a case where the updated map of the physical environment differs from the physical world knowledge received from ARD-1, ARP-2 may update and rectify the physical world knowledge received from ARD-1 such that such a piece of knowledge may become fresh and accurate again.

In an example, in step 1009, ARP-2 may return the knowledge validation result (e.g., response), which may include the rectified and updated physical world knowledge. For example, in a case where ARP-2 determines that a first piece of knowledge is still valid and accurate, the first piece of knowledge may/might not be returned (e.g., sent back) to ARD-1, which may already hold this knowledge. In a case where a second piece of knowledge was updated, information indicating the updated second piece of knowledge may be returned (e.g., transmitted) to ARD-1 such that ARD-1 may update e.g., the AR scene design.

In an example, (e.g., ARRSS on) ARD-2 may return (e.g., send information indicating) the physical world knowledge validation result 1010 to (e.g., ARRSC on) ARD-1. For example, for a given PO to be validated, the following information may be included in the physical world knowledge validation result 1010.

For example, the physical world knowledge validation result 1010 may indicate whether the PO information received from (e.g., ARRSC on) ARD-1 may be fresh or accurate. If not, the updated PO information may be included in the physical world knowledge validation result 1010.

For example, in case of a versioning approach (e.g., as described for sending a physical world knowledge validation request 1004), the physical world knowledge validation result 1010 may indicate whether the current version of PO information (e.g., held by ARRSC) is valid or not. If not, a new version number may be indicated in the physical world knowledge validation result 1010 and the updated PO information of this new version may be included in the physical world knowledge validation result 1010.

For example, in step 1011, ARRSC may further forward the knowledge validation result to ARA-1. ARA-1 may update its physical world knowledge about environment X, e.g., in a case where the knowledge validation result includes any knowledge updates or rectifications.

For example, in step 1012, ARA-1 may use the validated (e.g., updated) physical world knowledge to further design a customized AR scene, which may be used as ARD-1 may be moving in the physical environment X. Step 1012 may include similar features as steps 910-914 described for FIG. 9.

### Example of Cross-User Collaborative AR Processing for Pre-Notification About Moving PO Appearance

The following scenario is described herein: ARD-1 may be in a physical environment M (e.g., location A) and ARD-2 may be in another physical environment N (e.g., at location B). The two physical environments M, N may be close to each other, e.g., inter-connected via roads (e.g., streets). For example, one or more moving POs may appear in the viewport of ARD-1. Examples of moving POs may include vehicles traveling in the physical environment M. For example, moving PO(s) may appear in the viewport of ARD-1 and then leave the viewport, e.g., in a come-and-leave manner. Based on application logic, ARA-1 may superimpose one or more AR effects onto those moving PO(s), which may be displayed to the user of ARD-1. For example, the moving PO(s) may appear in the viewport of ARD-1 (e.g., only) for a limited period, such as e.g., five to ten seconds. ARA-1 may complete the AR design and deployment, which may include recognizing moving PO(s), determining whether a moving POs may be a PTO, determining the AR effect to be applied on the moving PTO, preparing (e.g., downloading) a VO (if not locally available) and superimposing the VO onto the PTO in a case where the PTO appears in the viewport of ARD-1. Such AR processing with stringent time constraints may be based on ARA-1 having access to high-performance computing capability, which may/might not be available (e.g., for resource-constrained ARDs). Embodiments described herein allow to address this challenge from a different angle by leveraging collaborative AR processing among different ARDs. Embodiments described herein leverage that moving POs may be traveling among different adjacent physical environments (e.g., physical environment M and physical environment N). For example, a vehicle appearing (e.g., running) at location B may soon arrive at location A, e.g., after one or two minutes. Embodiments described herein propose that different ARDs may collaborate to exchange information about the moving POs, such that an ARD may have more time to design (e.g., prepare) an AR effect to be superimposed onto those moving POs e.g., before the moving POs may appear in the viewport of its built-in camera. For example, (e.g., ARA-1 on) the ARD-1 (at location A) may leverage the video frames captured by another nearby ARD-2 (at location B) in the following way: in a case where the ARD-2 (operating as an ARRP) identifies a moving PO, which may be traveling towards a (e.g., certain) direction (e.g., towards location A), ARD-2 may send a pre-notification to ARD-1 indicating this detected moving PO, e.g., before this moving PO may appear in the viewport of ARD-1. For example, ARD-1 may know in advance what kind of moving PO may appear in its own viewport (e.g., soon) and may have more time to create and prepare the AR effect to be superimposed onto this moving PO.

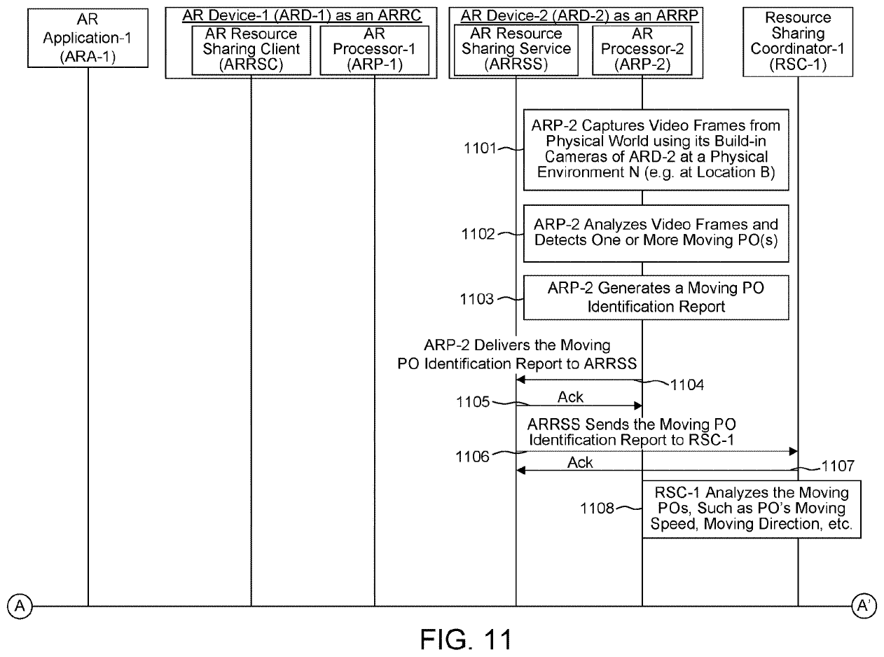

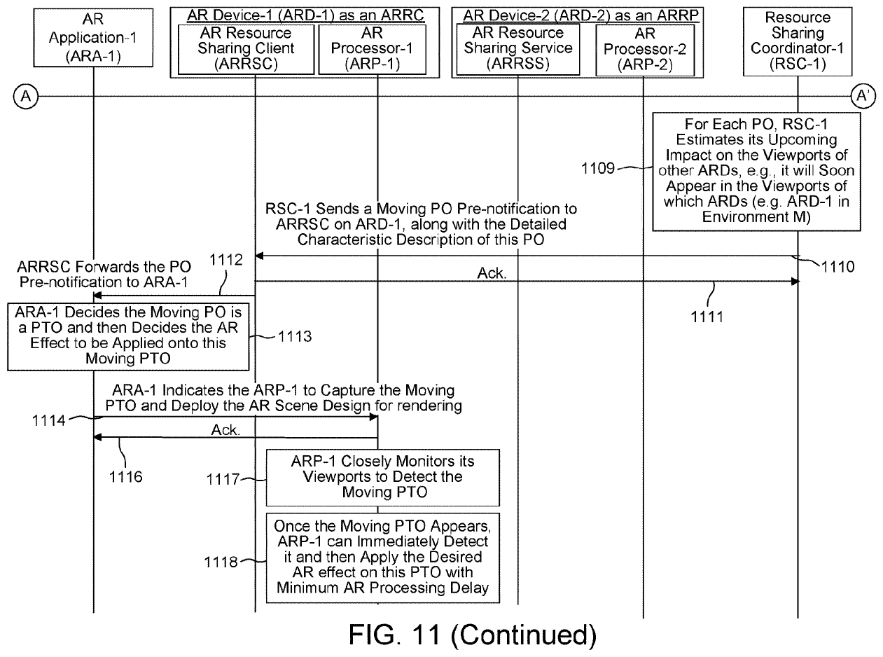

FIG. 11 is a diagram illustrating an example procedure for enabling pre-notification associated with moving PO appearance.

For example, ARD-1 may be located in a physical environment M (e.g., at location A) and ARD-2 may be located in a physical environment N (e.g., at location B), which may be not far from the physical environment M (e.g., adjacent to each other). ARD-1 and ARD-2 may be aware of the existence of RSC-1, which may be in charge of AR-related resource-sharing coordination.

In this example, the collaboration establishment procedure between ARRP and ARRC may/might not be performed. For example, RSC-1 may receive pre-notification from ARRP and may dispatch them to the appropriate ARRCs.

In an example, in step 1101, ARP-2 may capture video frame(s) using any of its (e.g., built-in) cameras of ARD-2. For example, ARD-2 may be in a busy street with a lot of moving POs on the street.

In an example, in step 1102, ARP-2 may analyze the video frame(s) and may perform image processing such as e.g., object recognition. For example, ARP-2 may detect and recognize one or more moving POs.

In an example, in step 1103, ARP-2 may generate a moving PO identification report, which may include (e.g., all) the identified moving POs. For example, a moving PO identification report may include a detailed description of a (e.g., each) PO, such as any of the type (e.g., a car, a food truck, or a double-deck bus), color, shape, moving speed, moving direction, etc.

In an example, in step 1104, ARP-2 may deliver the moving PO identification report to ARRSS.

In an example, in step 1105, ARRSS may send an acknowledgment to ARP-2.

In an example, in step 1106, ARRSS may determine to share this moving PO identification report with other ARDs, which may benefit from this report. For example, (e.g., ARRSS on) ARD-2 may send information indicating the moving PO identification report to RSC-1.

In an example, in step 1107, RSC-1 may send an acknowledgment to (e.g., ARRSS on) ARD-2.

In an example, in step 1108, RSC-1 may analyze the moving PO identification report. For example, for a (e.g., each) identified moving PO, RSC-1 may check any of its moving speed and moving direction.

In an example, in step 1109, for a (e.g., each) PO, RSC-1 may estimate its upcoming impact on the viewports of other ARDs, e.g., RSC-1 may estimate which moving PO may (e.g., soon) appear in the viewports of which ARDs (e.g., ARD-1 in the adjacent physical environment M). For example, those ARDs (including ARD-1) may be notified about the upcoming appearance of this PO.

In an example, in step 1110, RSC-1 may send a moving PO pre-notification to (e.g., ARRSC on) ARD-1 , along with (e.g., including) the detailed characteristic information of the moving PO(s). In another example, (e.g., ARRSS on) ARD-2 may receive information from RSC-1 indicating which ARDs may be notified about the upcoming appearance of one or more POs. For example, (e.g., ARRSS on) ARD-2 may send a moving PO pre-notification to (e.g., an ARRSC on) an ARD, e.g., ARD-1. More generally, ARD-1 may subscribe (e.g., send information indicating a subscription) and may receive pre-notifications from multiple ARDs for the PO(s) of interest.

In an example, in step 1111, (e.g., ARRSC on) ARD-1 may send an acknowledgment to RSC-1.

In an example, in step 1112, ARRSC may forward the PO pre-notification to ARA-1.

In an example, in step 1113, ARA-1 may evaluate the moving PO, and based on application logic, ARA-1 may determine whether this PO may be a PTO (e.g., which may be augmented with an AR effect). If so, ARA-1 may further determine what kinds of VO may be used for annotating the moving PTO. In a case where the VO is not locally available at ARD-1, ARA-1 may download the VO. For example, the AR design and preparation may be completed before this moving PO may appear in the viewport of ARD-1.

In an example, in step 1114, ARA-1 may deploy the designed AR scene to ARP-1 and may indicate ARP-1 to detect the moving PTO from its own viewport (captured by any of the built-in cameras of ARD-1).

In an example, in step 1116, ARP-1 may send an acknowledgment to ARA-1.

In an example, in step 1117, ARP-1 may capture the real-time video frames from any of its own cameras and may (e.g., closely) monitor and detect the moving PTO.

In an example, in step 1118, the PTO may appear and may be detected (based on the detailed characteristic information as indicated by ARA-1). ARP-1 may (e.g., immediately) apply the AR effect onto this moving PTO with a reduced AR processing delay.

In a case where no RSC is available, the procedure described herein may be conducted in an ad hoc approach. For example, ARD-2 (as an ARRP) may use local broadcast or any other communication technique to send pre-notifications indicating moving POs to other nearby ARDs (as ARRCs), e.g., which may be on adjacent streets/roads. For example, those nearby ARDs (as ARRCs) may perform subscriptions to ARD-2 (as an ARRP) and (e.g., only) the ARDs who may have subscribed to receive pre-notifications, may receive the pre-notifications indicating the moving POs.

### Example of 3 GPP SA4 Implementation

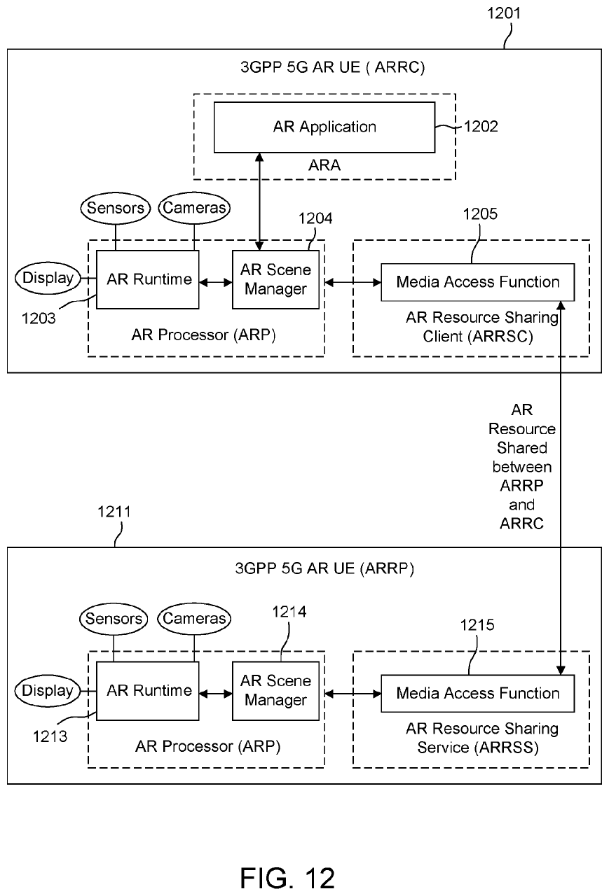

FIG. 12 is a diagram illustrating an example 3GPP SA4 implementation of the ARD architecture for supporting cross-user AR processing and resource sharing. 3GPP describes a 5G ARD as a WTRU. For example, a 5G AR WTRU in 3GPP may act (e.g., operate) as any of an ARRP and ARRC as described herein.

A 5G AR WTRU 1201, operating as an ARRC, may include an AR application 1202, which may comprise an AR controller for delivering an AR effect to the user based on application logic. The AR application 1202 described in 3GPP may be regarded as the ARA described herein. The 5G AR WTRU 1201 (as an ARRC) may comprise an AR runtime 1203, which may interact with various hardware, such as e.g., any of displays, sensors, and cameras, etc. The AR runtime 1203 may work with the AR scene manager 1204 of 5G AR WTRU, which may retrieve a scene description from an AR scene provider (e.g., server), to obtain scene content (e.g., data), may conduct the rendering, may send the rendered content to the AR runtime, such that the rendered virtual content(s) may be sent to the display for presenting to the user. Based on the functionalities of AR runtime 1203 and scene manager 1204 described in 3GPP SA4, the integration of those two components may be regarded as an AR Processor of the ARRC as described herein. A 5G AR WTRU 1201 may comprise a media access function (MAF) 1205, which may exchange AR/XR-related content with other entities. A MAF 1205 in a 5G AR WTRU 1201 (operating as an ARRC) may be regarded as an implementation of the ARRSC of ARRC described herein.

A 5G AR WTRU 1211, operating as an ARRP, may include an AR runtime 1213 and a scene manager 1214. For example, the integration of those two components on the ARRP can be regarded as an AR Processor of the ARRP as described herein. For example, the MAF 1215 in a 5G AR WTRU 1211 (in the role of ARRP) may be regarded as an implementation of the ARRSS of an ARRP described herein.

### Example of 3GPP SA2 Implementation

FIG. 13 is a diagram illustrating an example 3GPP SA2 implementation for the cross-user collaboration relationship establishment. For example, the ProSe function in 4G and/or the 5G direct discovery name management function (DDNMF) may be leveraged for enabling cross-user AR collaboration relationship between ARRP and ARRC. The RSC described herein may be implemented as a Prose application server in 3GPP. Two models for D2D direct discovery are described in clause 6.3.1 of 3GPP TS 23.304 V 18.0.0 (2022-12), “Proximity based Services (ProSe) in the 5G System (5GS)”. Model B direct discovery is taken as an example for describing the cross-user collaboration relationship establishment illustrated in FIG. 13. 3GPP Model B direct discovery is described in more detail in FIG. 6.3.1.3-1 of 3GPP TS 23.304 V18.0.0 (2022-12).

In an example, in step 1300, WTRU-1 and WTRU-2 may complete the service authorization for using ProSe function. For example, step 1300 may use the ProSe service authorization and provisioning procedure described in 3GPP TS 23.304 V 18.0.0 (2022-12), “Proximity based Services (ProSe) in the 5G System (5GS)”.

In an example, in step 1301, WTRU-2 may send a (e.g., 3GPP D2D) discovery request, for example as described in 3GPP TS 23.304 V 18.0.0 (2022-12) to a first network element (e.g., running the 5G DDNMF) for monitoring on PC5. For example, based on Model B direct discovery described in 3GPP, WTRU-2 may operate as a discoveree WTRU. For example, the (e.g., 3GPP D2D) discovery request may indicate the AR resource sharing capabilities of WTRU-2. For example, the (e.g., 3GPP D2D) discovery request may comprise any of the parameters indicated in the AR capability information as described in step 701 of FIG. 7A.

In an example, in step 1302, the first network element (e.g., running the 5G DDNMF) may further forward the request to a second network element (e.g., running a ProSe application server), which may include RSC-1 as illustrated in FIG. 7A. Steps 1301-1302 may correspond to step 701 of FIG. 7A.

In an example, in step 1303, the second network element (e.g., running the ProSe application server) may check related policies (e.g., with policy control function (PCF)), and may record AR resource sharing capabilities of WTRU-2, e.g., indicating what kinds of AR resources may be shared by WTRU-2. Such information may be recorded as the registration records. For example, the second network element (e.g., running ProSe application server) may authorize WTRU-2 to operate as an ARRP.

In an example, in step 1304, the second network element (e.g., running the ProSe application server) may send an acknowledgment to the first network element (e.g., running the 5G DDNMF) for WTRU-2's AR resource sharing capability registration.

In an example, in step 1305, the first network element (e.g., running the 5G DDNMF) may allocate (1) an AR resource solicitation filter and (2) an AR resource provisioning response code to WTRU-2. Their usage is described herein with steps 1319-1323.

In an example, in step 1306, the first network element (e.g., running the 5G DDNMF) may send back the assigned AR resource solicitation filter and the assigned AR resource provisioning response code to WTRU-2. For example, WTRU-2 may receive first information from the first network element, for communicating with another WTRU (such as e.g., WTRU-1). The first information may indicate the AR resource solicitation filter and the AR resource provisioning response code assigned to WTRU-2.

In an example, in step 1307, WTRU-2 may (e.g., start to) monitor a channel (e.g., PC5) for AR resource solicitation codes announced on the (e.g., PC5) channel.

In an example, in step 1308, WTRU-1 may move through an (e.g., unknown) physical environment X (e.g., soon). For example, WTRU-1 may determine to design a customized AR scene for the physical environment X.

In an example, in step 1309, WTRU-1 may determine to get some latest video frames captured from the physical environment X.

In an example, in step 1310, (e.g., ARA-1 on) WTRU-1 may send an AR resource-sharing request to ARRSC (e.g., on WTRU-1).

In an example, in step 1311, (e.g., ARRSC on) WTRU-1) may determine to contact (e.g., send information to) the first network element (e.g., running the 5G DDNMF service) for identifying a (e.g., target) ARRP e.g., using ProSe direct discovery messages.

In an example, (e.g., ARRSC on) WTRU-1 may send a discovery request 1312 to the first network element (e.g., running the 5G DDNMF) for announcing its AR resource solicitation request on PC5, along with a request for AR resource, e.g., indicating what kinds of AR resources may be requested. Based on Model B direct discovery described in 3GPP, WTRU-1 may operate as discoverer WTRU. For example, the discovery request 1312 may include any of the parameters included in (e.g., indicated by) the AR resource request 707 described in FIG. 7A.

In an example, in step 1313. the first network element (e.g., running the 5G DDNMF) may forward the request to the second network element (e.g., running the ProSe application server).

In an example, in step 1314, the second network element (e.g., running the ProSe application server) may check related policies (e.g., with PCF), and may authorize WTRU-1 to operate as an ARRC. The ProSe application server may check ARRP registration records (e.g., created in step 1303) and may determine that the request for AR resources from WTRU-1 may be served by WTRU-2, which may be a registered ARRP (based on step 1303). Step 1313 may correspond to step 708 of FIG. 7A.

In an example, in step 1315, the second network element (e.g., running the ProSe application server) may send an acknowledgment to the first network element (e.g., running the 5G DDNMF) indicating that the AR resource sharing request from WTRU-1 may be served by WTRU-2.

In an example, in step 1316, the first network element (e.g., running the 5G DDNMF) may allocate (1) an AR resource provisioning response filter and (2) an AR resource solicitation code to WTRU-1, based on the AR resource solicitation filter and the AR resource provisioning response code assigned to WTRU-2 in step 1305, such that they can be matched together.

In an example, in step 1317, the first network element (e.g., running the 5G DDNMF) may send second information to WTRU-1 for communicating with WTRU-2. For example, the second information may indicate the assigned AR resource provisioning response filter and the assigned AR resource solicitation code to WTRU-1.

In an example, in step 1318, WTRU-1 may (e.g., start to) announce (e.g., transmit information indicating) the received AR resource solicitation code (received in step 1317) on the (e.g., PC5) channel. For example, the information indicating the received AR resource solicitation code may further include (e.g., indicate) any parameter indicated by (e.g., included in) the AR resource sharing request 711 described in FIG. 7A.

In an example, in step 1319, WTRU-2 may determine that the AR resource solicitation code received from WTRU-1 may match its AR resource solicitation filter, which may indicate to WTRU-2 that WTRU-1 may be operating as an ARRC to be served. WTRU-2 may react to WTRU-1's request. In a case where WTRU-1 included information describing the requested AR resources in the announcement transmitted in step 1318, WTRU-1 may double-check to determine whether AR resource(s) requested by WTRU-1 may be provided based on any of its current workload and capability.

In an example, in step 1320, in a case where WTRU-2 determines to serve (e.g., to provide the requested AR resource(s) to) WTRU-1, WTRU-2 may announce (e.g., transmit information indicating) its AR resource provisioning code e.g., on PC5.

In an example, in step 1321, WTRU-1 may determine that the AR resource provisioning code received from WTRU-2 may match its AR resource provisioning response filter (assigned in step 1316), such that WTRU-1 may understand that its AR resource sharing request may be served by WTRU-2 as an ARRP.

The example described herein with FIG. 13 is based on a monitor/announcement technique to let ARD-1 and ARD-2 find each other. For example, in the above 3GPP SA2 example, the D2D direct discovery mechanism may be leveraged to enable WTRU-1 (e.g., ARD-1) to discover WTRU-2 (e.g., ARD-2). For example, a monitor/announcement technique may be used to realize the process of how ARD-1 may discover ARD-2. The example described herein with FIG. 13 differs from the example described (e.g., in step 709) of FIG. 7, where RSC-1 may transmit information to ARD-1 indicating the contact address of ARD-2 such that ARD-1 may discover ARD-2 and build a connection with it. The purpose of step 709 of FIG. 7A may be achieved by a monitor/announce technique (as illustrated by steps 1305, 1307, 1316, 1318, 1319, 1320, and 1321 of FIG. 13).

In an example, in step 1322, (e.g., ARRSC on) WTRU-1 may send a match report to the first network element (e.g., running the 5G DDNMF). The match report may include detailed information indicating how WTRU-1 and WTRU-2 may collaborate on AR processing, by e.g., including any of the parameters included in (e.g., indicated by) the AR resource request 707 described with FIG. 7A.

In an example, in step 1323, the first network element (e.g., running the 5G DDNMF) may confirm the match report (e.g. by sending a message (e.g., an ack) indicating a confirmation of the match report.

In an example, in step 1324, WTRU-1 and WTRU-2 may (e.g., start to) establish a D2D link using ProSe direct communication.

### Example of 3 GPP SA 6 Implementation

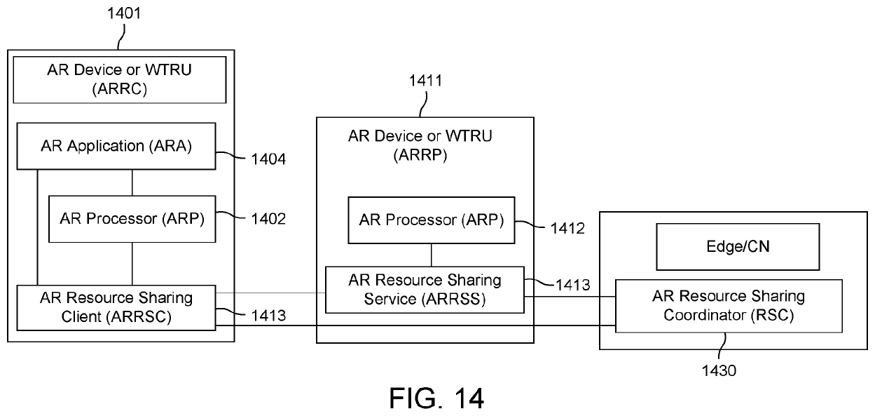

FIG. 14 is a diagram illustrating an example 3GPP SA6 implementation, aligned with the 3GPP SA6 architecture, based on a client-server model. For example, an AR device may be acting (e.g., operating) as an ARRC and/or an ARRP. An AR device acting (e.g., operating) as an ARRC 1401 may comprise an ARA 1404, which may be the focused AR application, e.g., the consumer of the AR resource shared by ARRP 1411 (in this SA6 implementation, ARA 1404 may be hosted on ARRC 1401). ARRC 1401 may comprise ARP 1402. ARP 1402 on ARRC 1401 may operate two functions: 1) to process the original AR resources shared by ARRP 1411 to extract the physical world knowledge and 2) to conduct the smart AR processing (e.g., rendering) for displaying the AR effect to the user. For example, ARRC 1401 may comprise ARRSC 1413, which may be seen as the client interacting with ARRP 1411. An ARD operating as an ARRP 1411 may comprise two modules. ARRP 1411 may comprise ARRSS 1413, which may be exposed as the service portal to receive one or more requests from ARRSC(s) 1413 of ARRC(s) 1401. ARRP 1411 may comprise an ARP 1412, which may assist ARRC 1401 in extracting the physical world knowledge from the original or raw AR resources (such as e.g., video frame(s)) captured by ARRP 1411. For example, RSC 1430 may be deployed at the edge of the network, such as e.g., in any of a gNB and a network function (NF) in the core network (CN) for matching an ARRC 1401 with an ARRP 1411.

### Example of ETSI ARF Implementation

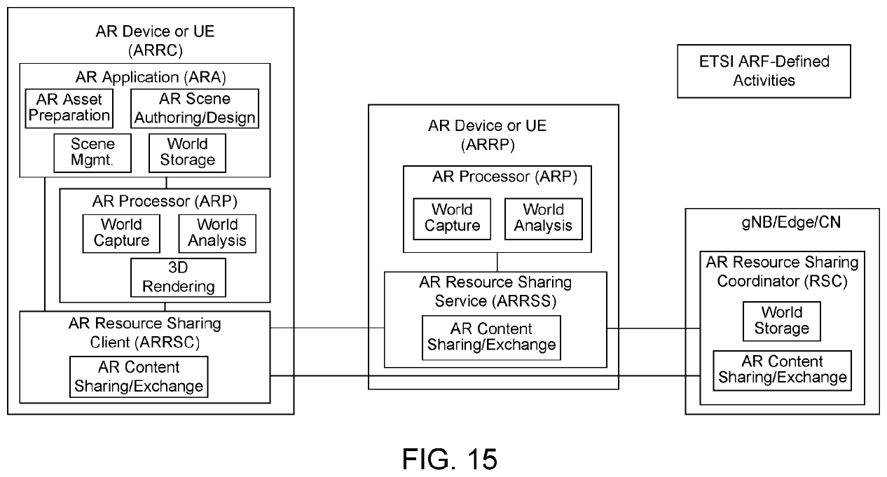

FIG. 15 is a diagram illustrating an example ETSI ARF implementation. The functional architecture of ETSI ARF describes the following activities of an AR application, including: 1) physical world knowledge management, including physical world capture, physical world analysis, semantic understanding, and physical world knowledge storage; 2) AR scene management (such as scene update), including AR scene design (e.g., using AR authoring tools for designing AR scene; a scene graph or scene description may comprise a tree-based data structure, which may be used to describe a scene, such as based on the glTF 2.0 format as described by MPEG) and AR asset preparation; 3) the designed scene may be rendered by a 3D rendering engine and presented to users through one or more display devices (such as e.g., optical see-through display, etc.). For example, the transmission part may allow to exchange AR-related data or content among different entities. For example, the ARA hosted on an ARRC described herein may operate activities such as e.g., any of AR asset preparation, AR scene design, and scene management and physical world knowledge storage as described in the ETSI ARF (so that ARA may leverage the knowledge to conduct the dynamic and customized scene design). ARP hosted by ARRC may operate activities such as e.g., any of world capture, and world analysis as described in ETSI ARF. For example, smart world analysis (such as quick PTO recognition may be done based on the physical world knowledge shared by ARRP). For example, on the ARRP side, ARP may operate activities such as e.g., any of world capture and world analysis to generate the physical world knowledge about a physical environment X and share the knowledge with ARRC. For example, an RSC may store world knowledge. For example, ARRSC on ARRC, ARRSS on ARRP, and RSC may operate the AR content sharing and exchange activity as described by ETSI ARF.

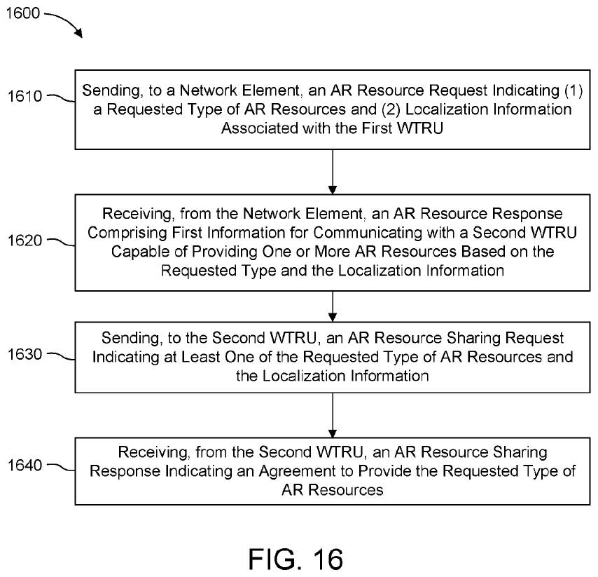

FIG. 16 is a diagram illustrating an example method 1600 for enabling cross-user collaboration relationship establishment. The method 1600 may be implemented in a first WTRU. As shown at 1610, the first WTRU may send, to a network element, an AR resource request indicating (1) a requested type of AR resources and (2) localization information associated with the first WTRU (e.g., and a physical environment). As shown at 1620, the first WTRU may receive from the network element an AR resource response comprising first information for communicating with a second WTRU capable of providing one or more AR resources based on the requested type (e.g., and the localization information). As shown at 1630, the first WTRU may send to the second WTRU an AR resource sharing request indicating at least one of the requested type of AR resources e.g., and the localization information. As shown at 1640, the first WTRU may receive from the second WTRU an AR resource sharing response indicating an agreement to provide the requested type of AR resources.

In an example, the first WTRU may receive from the second WTRU the one or more AR resources of the requested type e.g., associated with the physical environment. In an example, in response to the AR resource sharing request, the first WTRU may not receive an AR resource sharing response indicating an agreement to provide the requested type of AR resources. The first WTRU may receive the one or more resources of the requested type in response to the AR resource sharing request, implicitly indicating an agreement to provide the requested type of AR resources.

In an example, the first WTRU may determine an AR effect to be applied on an AR scene (e.g., of the physical environment) based on the AR resources.

In an example, the localization information associated with the first WTRU may indicate any of a current location of the first WTRU, a travel path of the first WTRU, and a moving speed of the first WTRU.

In an example, the AR resource sharing request may be transmitted to the second WTRU over a device-to-device communication link established between the first WTRU and the second WTRU.

In an example, the one or more AR resources may comprise any of one or more video frames of the physical environment and physical world information indicating one or more physical objects of the physical environment.

In an example, the one or more AR resources may comprise physical world information indicating one or more physical objects of the physical environment. The first WTRU may be further configured to select a physical object from the one or more physical objects of the physical environment and to apply the AR effect on the physical object.

In an example, the first WTRU may be further configured to download a virtual object associated with the selected physical object before the first WTRU may enter the physical environment.

In an example, the AR resource sharing request may indicate two different types of requested AR resources. For example, first AR resources of a first type may comprise one or more video frames (e.g., of a physical environment), and second AR resources of a second type may comprise physical world information indicating one or more physical objects (e.g., of the physical environment).

In an example, the first WTRU may be further configured to send to the second WTRU a physical world knowledge validation request comprising physical object information.

In an example, the physical object information may indicate one or more characteristics of one or more physical objects to be validated.

In an example, the one or more characteristics may comprise any of one or more positions, one or more shapes, one or more colors and one or more orientations of the one or more physical objects.

In an example, the physical object information may indicate at least one version number associated with at least one physical object.

In an example, the first WTRU may be further configured to receive from the second WTRU a physical world knowledge validation response including updated physical world information.

In an example, the first WTRU may update the AR effect to be applied on the AR scene based on the updated physical world information.

In an example, the first WTRU may be further configured to receive from the network element a notification indicating a moving physical object.

In an example, the notification may indicate that the moving physical object is moving towards the first WTRU.

In an example, the first WTRU may be further configured to determine that the moving physical object is to be augmented with a second AR effect.

In an example, the first WTRU may be further configured to determine the second AR effect.

In an example, the first WTRU may be further configured to capture one or more subsequent frames of the physical environment, and to detect the moving physical object in the captured one or more subsequent frames.

In an example, the first WTRU may be further configured to apply the second AR effect to the moving physical object, wherein the second AR effect may have been determined before the detection of the moving physical object in the captured one or more subsequent frames.

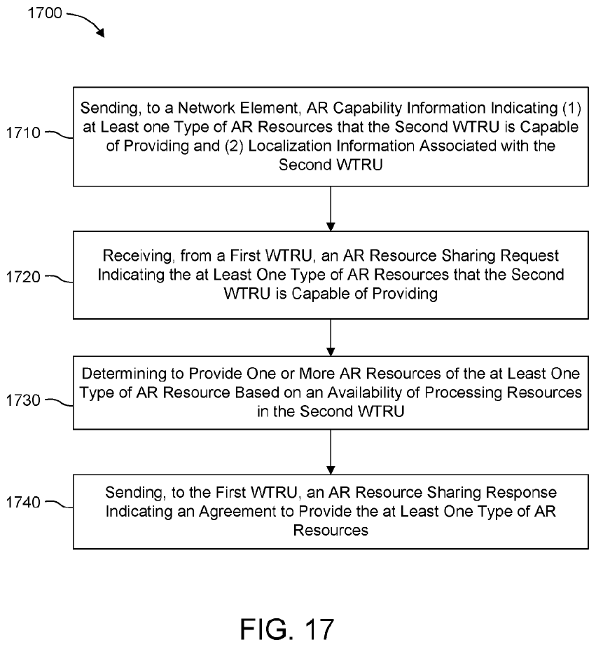

FIG. 17 is a diagram illustrating another example method 1700 for enabling cross-user collaboration relationship establishment. The method 1700 may be implemented in a second WTRU. As shown at 1710, the second WTRU may send to a network element AR capability information indicating (1) at least one type of AR resources that the second WTRU may be capable of providing and (2) localization information associated with the second WTRU (e.g., in a physical environment). As shown at step 1720, the second WTRU may receive from a first WTRU an AR resource sharing request indicating the at least one type of AR resources that the second WTRU may be capable of providing. As shown at 1730, the second WTRU may determine to provide one or more AR resources of the at least one type of AR resources (e.g., associated with the physical environment) based on an availability of processing resources in the second WTRU. As shown at 1740, the second WTRU may send to the first WTRU an AR resource sharing response indicating an agreement to provide the at least one type of AR resources.

In an example, the second WTRU may send to the first WTRU the one or more AR resources of the at least one type of AR resources (e.g., associated with the physical environment). In an example, in response to the AR resource sharing request, the second WTRU may not send an AR resource sharing response indicating an agreement to provide the at least one type of AR resources. The second WTRU may send the one or more resources of the at least one type in response to the AR resource sharing request, implicitly indicating an agreement to provide the at least one type of AR resources.

In an example, the AR capability information may further indicate any of a second WTRU identifier, AR hardware capabilities of the second WTRU, and AR software capabilities of the second WTRU.

In an example, the localization information associated with the second WTRU may indicate any of a current location of the second WTRU, a travel path of the second WTRU, and a moving speed of the second WTRU.

In an example, the AR resource sharing request may be received from the first WTRU over a device-to-device communication link established between the first WTRU and the second WTRU.

In an example, the second WTRU may capture one or more video frames from the physical environment.

In an example, the second WTRU may detect one or more physical objects in the physical environment based on the one or more video frames captured from the physical environment.

In an example, the one or more AR resources may comprise physical world information indicating the one or more physical objects detected in the physical environment.

In an example, the physical world information may indicate any of a position, an orientation, a color, a shape and a texture of at least one physical object of the one or more physical objects detected in the physical environment.

In an example, the AR capability information may indicate two different types of AR resources. For example, first AR resources of a first type may comprise one or more video frames (e.g., of a physical environment), and second AR resources of a second type may comprise physical world information indicating one or more physical objects (e.g., of a physical environment).

In an example, the second WTRU may be further configured to receive from the second WTRU a physical world knowledge validation request comprising physical object information.

In an example, the physical object information may indicate one or more characteristics of one or more physical objects to be validated.

In an example, the one or more characteristics may comprise any of one or more positions, one or more shapes, one or more colors and one or more orientations of the one or more physical objects.

In an example, the physical object information may indicate at least one version number associated with at least one physical object.

In an example, the second WTRU may be further configured to determine updated physical world information.

In an example, the second WTRU may be further configured to send to the first WTRU a physical world knowledge validation response including the updated physical world information.

In an example, the second WTRU may be further configured to capture one or more subsequent frames of the physical environment, and to detect a moving physical object in the captured one or more subsequent frames.

In an example, the second WTRU may be further configured to send to the network element a moving physical object identification report indicating the moving physical object.

In an example, the moving physical object identification report may indicate a direction along which the moving physical object may be moving.

In an example, the moving physical object identification report may indicate a speed of the moving physical object.

In an example, the second WTRU may be further configured to receive from the network element acknowledge information acknowledging a reception of the moving physical object identification report. Any characteristic, variant or embodiment described for a method is compatible with an apparatus device comprising means for processing the disclosed method, with a device comprising a processor and a transceiver operatively coupled to the processor, configured to process the disclosed method, with a computer program product comprising program code instructions and with a non-transitory computer-readable storage medium storing program instructions.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 16 or means-plus-function claim format, and any claim without the terms “means for” is not so intended.

1. A first wireless transmit/receive unit (WTRU) comprising a processor and a transmitter and a receiver operatively coupled to the processor, configured to:
send, to a network element, an augmented reality (AR) resource request indicating (1) a requested type of AR resources and (2) localization information associated with the first WTRU;
receive, from the network element, an AR resource response comprising first information for communicating with a second WTRU capable of providing one or more AR resources based on the requested type and the localization information, wherein the one or more AR resources are associated with a physical environment;
send, to the second WTRU, an AR resource sharing request indicating at least one of the requested type of AR resources associated with the physical environment, wherein the AR resource sharing request is sent to the second WTRU before the first WTRU enters in the physical environment; and
receive, from the second WTRU, the one or more AR resources of the requested type associated with the physical environment before the first WTRU enters in the physical environment.

2. The first WTRU of claim 1, configured to receive, from the second WTRU, an AR resource sharing response indicating an agreement to provide the one or more AR resources before receiving the one or more AR resources.

3. The first WTRU of claim 1, configured to determine an AR effect to be applied on an AR scene based on the one or more AR resources.

4. The first WTRU of claim 1, wherein the localization information associated with the first WTRU indicates any of a current location of the first WTRU, a travel path of the first WTRU, and a moving speed of the first WTRU.

5. The first WTRU of claim 1, wherein the AR resource sharing request is transmitted to the second WTRU over a device-to-device communication link established between the first WTRU and the second WTRU.

6. The first WTRU of claim 1, wherein the one or more AR resources comprise any of one or more video frames of the physical environment and physical world information indicating one or more physical objects of the physical environment.

7. The first WTRU of claim 6, wherein the physical world information indicates any of a position, an orientation, a color, a shape and a texture of at least one physical object of the one or more physical objects of the physical environment.

8. The first WTRU of claim 1, wherein the one or more AR resources comprise one or more video frames of the physical environment, and wherein the first WTRU is configured to detect one or more physical objects in the physical environment based on the one or more video frames of the physical environment.

9. The first WTRU of claim 3, wherein the one or more AR resources comprise physical world information indicating one or more physical objects of the physical environment, and wherein first WTRU is configured to select a physical object from the one or more physical objects of the physical environment and to apply the AR effect on the physical object.

10. The first WTRU of claim 9, configured to download a virtual object associated with the selected physical object before the first WTRU enters the physical environment.

11-22. (canceled)

23. A method implemented in a first wireless transmit/receive unit (WTRU), the method comprising:
sending, to a network element, an augmented reality (AR) resource request indicating (1) a requested type of AR resources and (2) localization information associated with the first WTRU;
receiving, from the network element, an AR resource response indicating a second WTRU capable of providing one or more AR resources based on the requested type and the localization information, wherein the one or more AR resources are associated with a physical environment;
sending, to the second WTRU, an AR resource sharing request indicating at least one of the requested type of AR resources associated with the physical environment, wherein the AR resource sharing request is sent to the second WTRU before the first WTRU enters in the physical environment; and
receiving, from the second WTRU, the one or more AR resources of the requested type associated with the physical environment before the first WTRU enters in the physical environment.

24. The method of claim 23, comprising receiving, from the second WTRU, an AR resource sharing response indicating an agreement to provide the one or more AR resources before receiving the one or more AR resources.

25. The method of claim 24, comprising determining an AR effect to be applied on an AR scene based on the one or more AR resources.

26-27. (canceled)

28. The method of claim 23, wherein the localization information associated with the first WTRU indicates any of a current location of the first WTRU, a travel path of the first WTRU, and a moving speed of the first WTRU.

29. The method of claim 23, wherein the AR resource sharing request is transmitted to the second WTRU over a device-to-device communication link established between the first WTRU and the second WTRU.

30. The method of claim 23, wherein the one or more AR resources comprise any of one or more video frames of the physical environment and physical world information indicating one or more physical objects of the physical environment.

31. The method of claim 30, wherein the physical world information indicates any of a position, an orientation, a color, a shape and a texture of at least one physical object of the one or more physical objects of the physical environment.

32. The method of claim 23, wherein the one or more AR resources comprise one or more video frames of the physical environment, and the method comprising detecting one or more physical objects in the physical environment based on the one or more video frames of the physical environment.

33. The method of claim 25, wherein the one or more AR resources comprise physical world information indicating one or more physical objects of the physical environment, and the method comprising selecting a physical object from the one or more physical objects of the physical environment and to apply the AR effect on the physical object.

34. The method of claim 33, comprising downloading a virtual object associated with the selected physical object before the first WTRU enters the physical environment.
